(19) United States
(12) Patent Application Publication
(10) Pub. No.: US 2026/0358750 A1
(43) Pub. Date: Nov. 12, 2026

(54) CARTRIDGE AND IMAGE FORMING APPARATUS

(71) Applicant: CANON KABUSHIKI KAISHA, Tokyo (JP)

(72) Inventor: KENJI MATSUDA, Shizuoka (JP)

(21) Appl. No.: 19/742,182

(22) Filed: Jul. 15, 2026

Related U.S. Application Data
(63) Continuation of application No. 18/911,388, filed on Oct. 10, 2024.

(30) Foreign Application Priority Data
Oct. 27, 2023 (JP) 2023-184921

(51) Int. Cl. G03G 21/18; G03G 21/16

(52) U.S. Cl. CPC G03G 21/1821; G03G 21/1676; G03G 21/1814; G03G 21/1842; G03G 2221/1884

(57) ABSTRACT

A cartridge includes a toner storage unit and a developing unit. A movement member moves between a first position and a second position in a second direction that intersects a first direction. The first direction includes an attachment direction in which the toner storage unit is attached to the developing unit and a detachment direction in which the toner storage unit is detached from the developing unit. The first position is a position where an engaging portion is engaged with an engaged portion such that the toner storage unit moves integrally with the developing unit when the toner storage unit is moved in the detachment direction. The second position is a position where the engaging portion is not engaged with the engaged portion such that the toner storage unit is withdrawn from the developing unit and moved when the toner storage unit is moved in the detachment direction.

### BACKGROUND OF THE INVENTION

### Field of the Invention

The present invention relates to a cartridge that may be detachably attached to an image forming apparatus for forming images on sheets, and to an image forming apparatus having the cartridge attached thereto.

### Description of the Related Art

Hitherto, in an image forming apparatus adopting a so-called electrophotographic system that records images using toner to a storage medium such as paper, a configuration is widely adopted in which a process cartridge capable of being replaced is provided by forming, as an integrated cartridge, a photosensitive member and a processing unit that acts on the photosensitive member. Further, a configuration is well known in which a toner cartridge storing toner is detachably attached to the process cartridge described above.

In this technical field, a cartridge configuration is developed where a state in which a toner cartridge is attached to the process cartridge and detachment thereof is regulated and a state in which detachment thereof is permitted are switchable by operating a lever disposed on the process cartridge (refer to Japanese Patent Application Laid-Open Publication No. 2008-185829). According to such a cartridge, in a state where the lever has been operated to attach the toner cartridge to the process cartridge and to regulate detachment thereof, the process cartridge and the toner cartridge are integrally detachably attached to the apparatus body. Further according to such a cartridge, in a state where the lever has been operated to permit detachment of the toner cartridge attached to the process cartridge, the toner cartridge may be detached alone with the process cartridge remaining attached to the apparatus body.

However, according to the cartridge disclosed in Japanese Patent Application Laid-Open Publication No. 2008-185829, the lever is designed to be operated in the up-down direction to switch the cartridges between a state in which the toner cartridge is attached to the process cartridge and detachment thereof is regulated and a state in which detachment thereof is permitted. Further according thereto, the operability for attaching and detaching the toner cartridge both integrally with the process cartridge and independently from the process cartridge was not good.

### SUMMARY OF THE INVENTION

According to a first aspect of the present invention, a cartridge includes a toner storage unit including a first toner storage portion configured to accommodate toner and having an outlet through which toner is discharged, a conveyance member configured to convey toner accommodated in the first toner storage portion toward the outlet, and a movement member configured to be movably with respect to the first toner storage portion and having an engaging portion, and a developing unit including a developing roller configured to bear toner, a second toner storage portion configured to accommodate toner and having an inlet configured to communicate with the outlet, a developing frame body configured to support the developing roller rotatably, and an engaged portion, the toner storage unit being attached detachably in a first direction. The movement member is configured to move between a first position and a second position in a second direction that intersects the first direction. The first direction includes an attachment direction in which the toner storage unit is attached to the developing unit and a detachment direction in which the toner storage unit is detached from the developing unit. The first position is a position where the engaging portion is engaged with the engaged portion such that the toner storage unit moves integrally with the developing unit in a case where the toner storage unit is moved in the detachment direction. The second position is a position where the engaging portion is not engaged with the engaged portion such that the toner storage unit is withdrawn from the developing unit and moved in the case where the toner storage unit is moved in the detachment direction.

According to a second aspect of the present invention, a cartridge includes a toner storage unit including a first toner storage portion configured to accommodate toner and having an outlet through which toner is discharged, a conveyance member configured to convey toner accommodated in the first toner storage portion toward the outlet, a movement member configured to be movably with respect to the first toner storage portion, and an engaging portion, and a developing unit including a developing roller configured to bear toner, a second toner storage portion configured to accommodate toner and having an inlet configured to communicate with the outlet, a developing frame body configured to support the developing roller rotatably, and an engaged portion, the toner storage unit being attached detachably in a first direction. The movement member is configured to move between a first position and a second position in a second direction that intersects the first direction. The first direction includes an attachment direction in which the toner storage unit is attached to the developing unit and a detachment direction in which the toner storage unit is detached from the developing unit. The first position is a position where the engaging portion is engaged with the engaged portion such that the toner storage unit moves integrally with the developing unit in a case where the toner storage unit is moved in the detachment direction. The second position is a position where the engaging portion is not engaged with the engaged portion such that the toner storage unit is withdrawn from the developing unit and moved in the case where the toner storage unit is moved in the detachment direction.

According to a third aspect of the present invention, an image forming apparatus configured to form an image on a sheet includes an apparatus body, and a cartridge detachably attached to the apparatus body. The cartridge includes a toner storage unit including a first toner storage portion configured to accommodate toner and having an outlet through which toner is discharged, a conveyance member configured to convey toner accommodated in the first toner storage portion toward the outlet, and a movement member configured to be movably with respect to the first toner storage portion and having an engaging portion, and a developing unit including a developing roller configured to bear toner, a second toner storage portion configured to accommodate toner and having an inlet configured to communicate with the outlet, a developing frame body configured to support the developing roller rotatably, and an engaged portion, the toner storage unit being attached detachably in a first direction. The movement member is configured to move between a first position and a second position in a second direction that intersects the first direction. The first direction includes an attachment direction in which the toner storage unit is attached to the developing unit and a detachment direction in which the toner storage unit is detached from the developing unit. The first position is a position where the engaging portion is engaged with the engaged portion such that the toner storage unit moves integrally with the developing unit in a case where the toner storage unit is moved in the detachment direction. The second position is a position where the engaging portion is not engaged with the engaged portion such that the toner storage unit is withdrawn from the developing unit and moved in the case where the toner storage unit is moved in the detachment direction.

According to a fourth aspect of the present invention, an image forming apparatus configured to form an image on a sheet includes an apparatus body, and a cartridge detachably attached to the apparatus body. The cartridge includes a toner storage unit including a first toner storage portion configured to accommodate toner and having an outlet through which toner is discharged, a conveyance member configured to convey toner accommodated in the first toner storage portion toward the outlet, a movement member configured to be movably with respect to the first toner storage portion, and an engaging portion, and a developing unit including a developing roller configured to bear toner, a second toner storage portion configured to accommodate toner and having an inlet configured to communicate with the outlet, a developing frame body configured to support the developing roller rotatably, and an engaged portion, the toner storage unit being attached detachably in a first direction. The movement member is configured to move between a first position and a second position in a second direction that intersects the first direction. The first direction includes an attachment direction in which the toner storage unit is attached to the developing unit and a detachment direction in which the toner storage unit is detached from the developing unit. The first position is a position where the engaging portion is engaged with the engaged portion such that the toner storage unit moves integrally with the developing unit in a case where the toner storage unit is moved in the detachment direction. The second position is a position where the engaging portion is not engaged with the engaged portion such that the toner storage unit is withdrawn from the developing unit and moved in the case where the toner storage unit is moved in the detachment direction.

Further features of the present invention will become apparent from the following description of exemplary embodiments with reference to the attached drawings.

### BRIEF DESCRIPTION OF THE DRAWINGS

FIG. 1 is an entire schematic drawing illustrating an image forming apparatus according to a first embodiment.

FIG. 2A is a cross-sectional view illustrating a cartridge.

FIG. 2B is a cross-sectional view illustrating a state in which a toner cartridge is detached from a process cartridge.

FIG. 3A is a perspective view illustrating a state in which the toner cartridge is viewed from a holding portion side.

FIG. 3B is a perspective view illustrating a state in which the toner cartridge is viewed from an outlet shutter side.

FIG. 4A is a perspective view illustrating a state in which the process cartridge is viewed from an inlet shutter side.

FIG. 4B is a perspective view in which a portion of FIG. 4A is omitted.

FIG. 5A is a partial cross-sectional view illustrating a state in which the toner cartridge is detached from the process cartridge.

FIG. 5B is a partial cross-sectional view illustrating a state in which the toner cartridge is in midway of being attached to the process cartridge.

FIG. 5C is a partial cross-sectional view illustrating a state in which the toner cartridge is attached to the process cartridge.

FIG. 6A is a partially omitted perspective view illustrating a state in which the toner cartridge is attached to the process cartridge and in which an engaging portion and an engaged portion are not engaged, viewed from the inlet shutter side.

FIG. 6B is a perspective view illustrating a state in which the toner cartridge of FIG. 6A is viewed from the outlet shutter side.

FIG. 7A is a partially omitted perspective view illustrating a state in which the toner cartridge is attached to the process cartridge and in which the engaging portion and the engaged portion are engaged, viewed from the inlet shutter side.

FIG. 7B is a perspective view illustrating a state in which the toner cartridge of FIG. 7A is viewed from the outlet shutter side.

FIG. 8A is a perspective view illustrating the image forming apparatus.

FIG. 8B is a perspective view illustrating the image forming apparatus in a state where a cover is opened.

FIG. 8C is a cross-sectional view of a cartridge opening.

FIG. 9A is a perspective view illustrating a state in which the cartridge is stored in a cartridge storage portion.

FIG. 9B is a perspective view illustrating a state in which the cartridge is stored in the cartridge storage portion.

FIG. 10A is a partial cross-sectional view illustrating a state in which the cartridge is detached from the cartridge storage portion.

FIG. 10B is a partial cross-sectional view illustrating a state in which the cartridge is in midway of attachment to the cartridge storage portion.

FIG. 10C is a partial cross-sectional view illustrating a state in which the cartridge is attached to the cartridge storage portion.

FIG. 11A is a perspective view illustrating a state in which the toner cartridge is detached from the process cartridge stored in the cartridge storage portion.

FIG. 11B is a perspective view illustrating a state in which the cartridge is detached from the cartridge storage portion.

FIG. 11C is a perspective view illustrating a state in which the toner cartridge is detached from the process cartridge.

FIG. 12A is a perspective view illustrating a cartridge in which a holding portion is positioned at a first position.

FIG. 12B is a perspective view illustrating a cartridge in which a holding portion is positioned at a second position.

FIG. 13A is a perspective view illustrating a holding portion according to a first modified example.

FIG. 13B is a perspective view illustrating a holding portion according to a second modified example.

FIG. 13C is a perspective view illustrating a holding portion according to a third modified example.

FIG. 13D is a perspective view illustrating a holding portion according to a fourth modified example.

FIG. 14A is a perspective view illustrating a toner cartridge according to a second embodiment in which a holding portion is positioned at a first position.

FIG. 14B is a perspective view illustrating the toner cartridge according to the second embodiment in which the holding portion is positioned at a second position.

FIG. 15A is a perspective view illustrating a toner cartridge according to a third embodiment in which a holding portion is positioned at a first position.

FIG. 15B is a perspective view illustrating the toner cartridge according to the third embodiment in which the holding portion is positioned at a second position.

FIG. 16A is a perspective view illustrating a state in which a regulation lever is positioned at a regulation position in a cartridge according to a fourth embodiment.

FIG. 16B is an enlarged view of FIG. 16A.

FIG. 16C is a perspective view illustrating a stopper release groove of a cartridge opening according to the fourth embodiment.

FIG. 17A is a cross-sectional view illustrating a state in which the cartridge according to the fourth embodiment is detached from the apparatus body.

FIG. 17B is an enlarged view of FIG. 17A.

FIG. 17C is a cross-sectional view illustrating a state in which the cartridge according to the fourth embodiment is attached to the apparatus body.

FIG. 17D is an enlarged view of FIG. 17C.

FIG. 18A is a cross-sectional view illustrating a state in which a toner cartridge is detached from a process cartridge in a cartridge according to a fifth embodiment.

FIG. 18B is a perspective view illustrating the toner cartridge according to the fifth embodiment from an outlet shutter side.

FIG. 18C is a perspective view illustrating the process cartridge according to the fifth embodiment from an inlet shutter side.

FIG. 19A is a cross-sectional view of the cartridge according to the fifth embodiment, illustrating a state in which the toner cartridge is attached to the process cartridge and a holding portion is positioned at a second position.

FIG. 19B is a cross-sectional view of the cartridge according to the fifth embodiment, illustrating a state in which the toner cartridge is attached to the process cartridge and the holding portion is positioned at a first position.

### DESCRIPTION OF THE EMBODIMENTS

### First Embodiment

### Overall Configuration

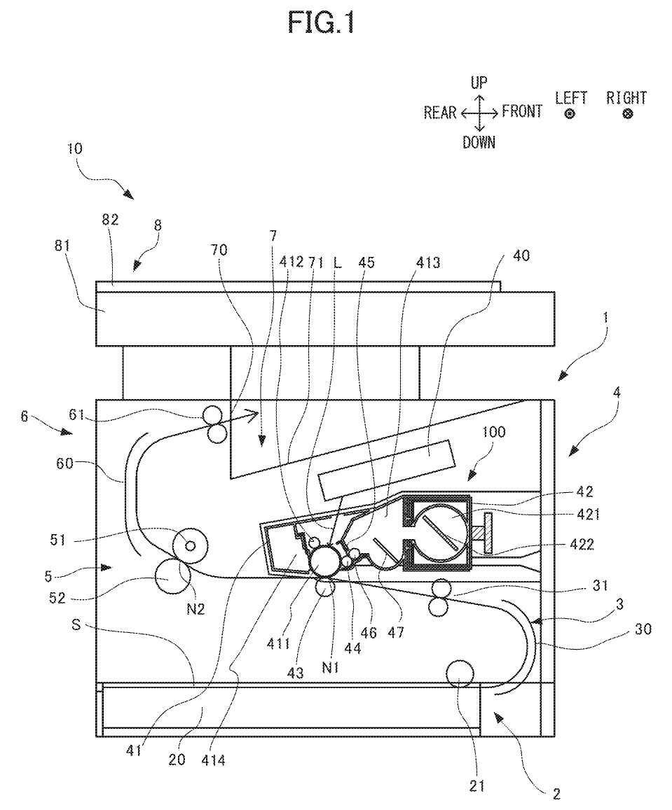

At first, a first embodiment of the present disclosure will be described. An image forming apparatus 10 is a laser beam printer adopting an electrophotographic system that forms a monochromatic toner image. FIG. 1 is an overall schematic cross-sectional view illustrating the image forming apparatus 10.

In the following description, the respective directions are defined as illustrated by the respective arrows indicating each direction on FIG. 1. That is, an upper direction on the sheet of FIG. 1 is referred to as up, a right direction on the sheet is referred to as a front direction or front, a left direction on the sheet is referred to as a rear direction or back, and a back direction of the sheet is referred to as a right direction.

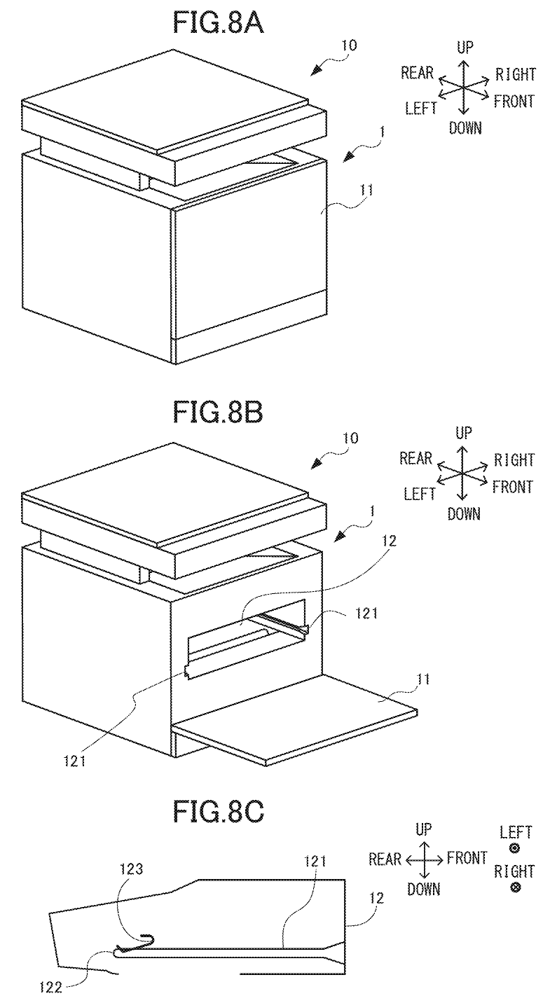

As illustrated in FIG. 1, the image forming apparatus 10 includes an apparatus body 1, a document reading unit 8, a cartridge 100, and a front cover 11 (refer to FIG. 8B). The apparatus body 1 includes a sheet feeding portion 2 that feeds a sheet S supported thereon, a conveyance portion 3 that conveys the sheet S from the sheet feeding portion 2, an image forming unit 4 that forms an image on the sheet S conveyed by the conveyance portion 3, and a fixing portion 5 that fixes the image transferred to the sheet S. Further, the apparatus body 1 includes a sheet discharge portion 6 through which the sheet S on which an image is fixed is discharged to an exterior of the apparatus, and a supporting portion 7 on which the sheet S subjected to image forming is supported. According to the present embodiment, the sheet feeding portion 2 is arranged at a lower portion of the apparatus body 1. The conveyance portion 3 is arranged on the front direction of the apparatus body 1. The image forming unit 4 is arranged at a center portion of the apparatus body 1. The fixing portion 5 and the sheet discharge portion 6 are arranged at a rear direction of the apparatus body 1. The supporting portion 7 is arranged at an upper portion of the apparatus body 1. The document reading unit 8 is arranged at an upper portion of the supporting portion 7.

The image forming apparatus denotes an apparatus that forms an image on a sheet used as a recording medium based on image information entered from an external PC or image information read from a document, and that includes a printer, a copying machine, a facsimile, and a multifunction device. Further, in addition to a main body having an image forming function, the image forming apparatus may have auxiliary devices such as an option feeder, an image reading apparatus, and a sheet processing apparatus connected thereto, but the entire system including the auxiliary devices connected to the main body is also recognized as one type of image forming apparatus. Further, sheets and documents may include paper such as printing paper and envelopes, plastic films such as overhead projector sheets, and cloths.

### Sheet Feeding Portion and Conveyance Portion

The sheet feeding portion 2 and the conveyance portion 3 will be described with reference to FIG. 1. The sheet feeding portion 2 includes a cassette portion 20 and a pickup portion 21. The cassette portion 20 accommodates or stores the sheet S in a stacked manner. The pickup portion 21 picks up the sheets S stored in a stacked manner one by one. The conveyance portion 3 includes a conveyance guide 30 and a conveyance roller pair 31. The conveyance guide 30 is a guide that regulates a movement locus of the sheet S and guides the sheet. The conveyance roller pair 31 is a roller pair that conveys the sheet S to the image forming unit 4.

The pickup portion 21 operates according to an image forming operation to feed the sheets S on the cassette portion 20 one at a time to the conveyance portion 3. The sheet S is conveyed along the conveyance guide 30. During the image forming operation, the conveyance roller pair 31 is driven by a drive transmission unit not shown, and conveys the sheet S to the image forming unit 4. The conveyance roller pair 31 may be composed of a registration roller pair that corrects skewing of the sheet S. In this case, the conveyance roller pair 31 performs an operation to stop and have the sheet S standby during the image forming operation, and an operation to convey the sheet S to the image forming unit 4, based on a predetermined sequence. Then, during an image forming process, which is a subsequent process, positioning of the toner image and the sheet S is performed.

### Image Forming Unit

Next, the image forming unit 4 will be described with reference to FIG. 1. The image forming unit 4 includes a laser scanner 40, the cartridge 100, and a transfer roller 43. The cartridge 100 includes a process cartridge 41 and a toner cartridge 42. The laser scanner 40 is a latent image forming unit. The laser scanner 40 irradiates a laser light L obtained by processing the image information by a processing unit not shown to a photosensitive drum 411. The photosensitive drum 411 irradiated with the laser light L bears an electrostatic latent image on a surface thereof.

The process cartridge 41 includes the photosensitive drum 411, a charge roller 412, a developing portion 413, and a cleaning portion 414. The photosensitive drum 411 is an example of an image bearing member that bears an electrostatic latent image and also bears a toner image. The charge roller 412 is a charging unit that provides a charging processing to the photosensitive drum 411. The developing portion 413 is a developing unit that develops the toner image on the electrostatic latent image of the photosensitive drum 411. The cleaning portion 414 is a cleaning unit that cleans a residue remaining on the photosensitive drum 411. The transfer roller 43 is a transfer unit that is disposed to face the photosensitive drum 411 and that transfers the toner image borne on the photosensitive drum 411 to the sheet S.

The developing portion 413 includes a developing roller 44, a developing blade 45, a supplying roller 46, a steering member 47, and a developing chamber 62. The developing roller 44 is a toner bearing unit that bears toner and that develops the electrostatic latent image formed on the photosensitive drum 411 as a toner image. The developing blade 45 is a regulation unit that regulates a layer thickness of toner on the surface of the developing roller 44. The supplying roller 46 is a supplying unit that supplies toner of the developing portion 413 to the developing roller 44. The steering member 47 is a steering unit that steers toner in the developing portion 413. The developing chamber 62 is an example of a second toner storage portion, designed to store toner, and having an inlet 41a that is designed to communicate with an outlet 42a.

The toner cartridge 42 includes a toner storage portion 421 and a conveyance paddle 422. The toner storage portion 421 is an example of a first toner storage portion, which is composed of an approximately cylindrical container, that is configured to store toner, and that is provided with the outlet 42a through which toner is discharged. According to the present embodiment, a longitudinal direction of the toner cartridge 42 is configured as a right-left direction, that is, a rotational axis direction of the developing roller 44. The conveyance paddle 422 is a thin plate-shaped member that is disposed rotatably in the interior of the toner storage portion 421 and that serves as a conveyance unit conveying toner stored in the toner storage portion 421 to the developing portion 413.

A predetermined bias is applied to the charge roller 412 from a bias application unit not shown, which subjects a surface of the photosensitive drum 411 to a charging process. An electrostatic latent image is formed on a surface of the photosensitive drum 411 by the laser light L. Toner stored in the toner storage portion 421 is conveyed by the conveyance paddle 422 to the developing portion 413. The toner conveyed to the developing portion 413 is steered by the steering member 47 and sent to the supplying roller 46. The supplying roller 46 supplies toner to the developing roller 44. Toner supplied by the supplying roller 46 is regulated of its layer thickness by the developing blade 45 and charged by frictional charging. A predetermined bias is applied to the developing roller 44 by a bias application unit not shown. Toner borne on the developing roller 44 develops an image on the electrostatic latent image based on a potential difference between the applied bias and the electrostatic latent image formed on the photosensitive drum 411. As described, a toner image is borne on the photosensitive drum 411.

Now, the sheet S conveyed by the conveyance portion 3 is conveyed to a transfer nip N1 between the photosensitive drum 411 and the transfer roller 43. A predetermined bias is applied to the transfer roller 43 by a bias application unit not shown. The toner image borne on the photosensitive drum 411 is transferred to the sheet S by a potential difference of bias applied to the transfer roller 43. Residual toner that has not been transferred is scraped from the surface of the photosensitive drum 411 by the cleaning portion 414, and cleaned and collected by a collecting portion.

### Fixing Portion

Next, the fixing portion 5 will be described with reference to FIG. 1. The fixing portion 5 includes a heating roller 51 and a pressure roller 52. The heating roller 51 is a heating unit. A heating member not shown is incorporated in the heating roller 51, and the heating roller 51 is heated thereby. The pressure roller 52 is a pressing unit. The pressure roller 52 is pressed by a pressing unit not shown toward the heating roller 51. Further, the heating roller 51 and the pressure roller 52 are driven by a driving unit not shown. The sheet S having a toner image formed on a surface thereof and conveyed from the image forming unit 4 is nipped by a fixing nip N2 formed of the heating roller 51 and the pressure roller 52. Now, the toner image is heated and pressed, and fixed to the sheet S.

### Discharge Portion and Supporting Portion

Next, the sheet discharge portion 6 and the supporting portion 7 will be described with reference to FIG. 1. The sheet discharge portion 6 includes a sheet discharge guide 60 and a sheet discharge roller pair 61. The supporting portion 7 includes a sheet discharge opening 70 and a sheet discharge tray 71. The sheet discharge guide 60 is a conveyance guide unit of the sheet S. The sheet discharge roller pair 61 is an example of a discharge portion, which is driven by a driving unit not shown and discharges sheets toward a sheet discharging direction, i.e., front direction. The sheet discharge opening 70 is an opening through which the sheet S having the toner image recorded and fixed thereto is discharged to an exterior of the apparatus body 1. The sheet discharge tray 71 is a supporting unit for supporting the sheets S on which toner images are recorded and fixed. The sheet S on which the toner image has been fixed by the fixing portion 5 is conveyed by the sheet discharge roller pair 61 via the sheet discharge guide 60. The sheet S is discharged by the sheet discharge roller pair 61 through the sheet discharge opening 70. The sheet S is supported on the sheet discharge tray 71 serving as a discharge supporting unit.

### Document Reading Unit

Next, the document reading unit 8 will be described with reference to FIG. 1. The document reading unit 8 is a document reading unit that reads the document on which an image has been recorded, and includes a document reading table 81 and a document holding portion 82. The document reading table 81 includes an image reading sensor not shown, and reads image and text information recorded on the document. The image being read is converted into electronic data by a control unit not shown. The electronic data may be converted by the control unit to execute an image forming operation and recorded as toner image onto the sheet S. The toner image being formed in this manner may be utilized as a copy image. The control unit may also magnify or reduce the image based on the electronic data. Further, the control unit may store and reuse the electronic data. When reading the document, the document is placed on the document reading table 81. Thereafter, the document is held by the document holding portion 82. By holding the document, the document may be closely adhered to the document reading table 81, and improvement of reading accuracy may be expected. Then, an operating portion not shown is operated to perform copying or record electronic data.

### Image Forming Operation

When an image forming instruction is output to the image forming apparatus 10, an image forming process by the image forming unit 4 is started based on image information entered from an external computer connected to the image forming apparatus 10 or from the document reading unit 8. The laser scanner 40 irradiates a laser light toward the photosensitive drum 411 based on the image information being entered. In this state, the photosensitive drum 411 is charged in advance by the charge roller 412, and by having the laser light L irradiated thereon, an electrostatic latent image is formed on the photosensitive drum 411. Thereafter, the electrostatic latent image is developed by the developing roller 44, and a monochromatic toner image is formed on the photosensitive drum 411.

In parallel with the image forming process described above, the sheet S is fed from the sheet feeding portion 2. The sheet S conveyed from the sheet feeding portion 2 via the conveyance portion 3 has a toner image on the photosensitive drum 411 transferred thereto by an electrostatic load bias applied to the transfer roller 43 at the transfer nip N1. The sheet S to which the toner image has been transferred has a predetermined heat and pressure applied thereto at the fixing nip N2 by the heating roller 51 and the pressure roller 52 of the fixing portion 5, by which toner is melted and fixed thereto. The sheet S having passed through the fixing portion 5 is guided by the sheet discharge guide 60 to the sheet discharge roller pair 61, and discharged by the sheet discharge roller pair 61 onto the sheet discharge tray 71. Based on a set of operations described above, a toner image is formed on the sheet S, and the sheet S is discharged to the exterior of the apparatus body 1 and supported thereon. Hereafter, the above-descried set of operations is called an image forming operation.

### Outline of Cartridge

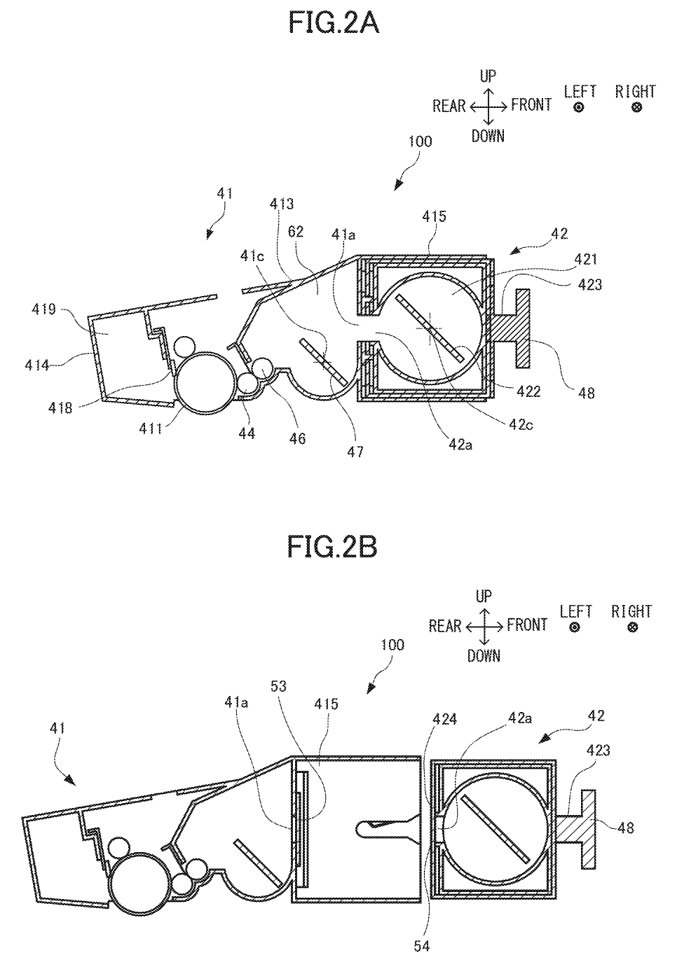

Next, with reference to FIGS. 2A and 2B, an outline of the cartridge 100 according to the present embodiment will be described. The cartridge 100 includes the process cartridge 41 and the toner cartridge 42. FIG. 2A is a cross-sectional view illustrating an outline of the process cartridge 41 and the toner cartridge 42 in a state where the process cartridge 41 and the toner cartridge 42 are connected. FIG. 2B is a cross-sectional view illustrating an outline of the process cartridge 41 and the toner cartridge 42 in a state where the connecting of the process cartridge 41 and the toner cartridge 42 is released and where they are separated.

As illustrated in FIG. 2A, the toner cartridge 42 is an example of a toner storage unit, and includes the outlet 42a, the toner storage portion 421, the conveyance paddle 422, and an operating portion 423. The outlet 42a is an opening through which toner stored in the toner storage portion 421 is discharged. The conveyance paddle 422 is an example of a conveyance member, and conveys toner stored in the toner storage portion 421 toward the outlet 42a. The operating portion 423 is a portion through which the toner cartridge 42 is operated. The operating portion 423 includes a holding portion 48, which is a portion that the user holds when operating the toner cartridge. According to the present embodiment, the holding portion 48 has a plate-like shape in which the front-rear direction corresponds to the planar direction. Thereby, when the user operates the toner cartridge in the front-rear direction and the right-left direction, the user may hold the holding portion 48 easily and operate the same.

The process cartridge 41 is an example of a developing unit, which includes the photosensitive drum 411, the developing portion 413, the cleaning portion 414, and an attachment portion 415. Further, the process cartridge 41 includes a casing 410 that supports the developing roller 44 and the photosensitive drum 411 rotatably as an example of a developing frame body. The attachment portion 415 is a portion that supports the toner cartridge 42 attachably and detachably. The attachment portion 415 includes the inlet 41a. The inlet 41a is an opening through which toner discharged through the outlet 42a is received. According to the present embodiment, the process cartridge 41 serving as the developing unit includes the photosensitive drum 411, but the present technique is not limited thereto, and it may be a unit that does not include the photosensitive drum 411.

The conveyance paddle 422 is supported rotatably about a center of rotation 42c. The conveyance paddle 422 rotates in a clockwise direction in the drawing by a drive transmission unit not shown. Toner stored in the toner storage portion 421 is conveyed toward the outlet 42a by the conveyance paddle 422. Toner being conveyed is passed through the outlet 42a and the inlet 41a to be conveyed to the developing portion 413. The steering member 47 is supported rotatably about a center of rotation 41c. The steering member 47 rotates in a clockwise direction in the drawing by a drive transmission unit not shown. The steering member 47 steers toner conveyed from the toner cartridge 42 and toner already stored in the developing portion 413. Toner being steered is conveyed toward the supplying roller 46. Conveyed toner is supplied by the supplying roller 46 to the developing roller 44. Toner supplied to the developing roller 44 is developed according to the electrostatic latent image formed on the photosensitive drum 411. Toner that has not been transferred is removed from the photosensitive drum 411 by a cleaning blade 418 that is included in the cleaning portion 414, and stored in a waste toner storage 419 included in the cleaning portion 414.

As illustrated in FIG. 2B, the toner cartridge 42 includes a connecting portion 424 for connection to the process cartridge 41. The attachment portion 415 included in the process cartridge 41 includes an inlet shutter 53. The inlet shutter 53 is supported in a manner capable of opening and closing the inlet 41a. The connecting portion 424 is a portion for connecting the toner cartridge 42 to the process cartridge 41. The connecting portion 424 includes an outlet shutter 54. The outlet shutter 54 is disposed to open and close the outlet 42a.

As illustrated in FIG. 2A, in a state where the toner cartridge 42 and the process cartridge 41 are connected and an image forming operation is performed, the outlet shutter 54 opens the outlet 42a and the inlet shutter 53 opens the inlet 41a. As illustrated in FIG. 2B, in a state where the toner cartridge 42 and the process cartridge 41 are separated, the outlet shutter 54 closes the outlet 42a and the inlet shutter 53 closes the inlet 41a. That is, when the toner cartridge 42 is separated from the process cartridge 41, the opening through which toner passes is closed by shutter members disposed on the respective cartridges. Therefore, toner may be prevented from leaking to the exterior when the toner cartridge 42 and the process cartridge 41 are separated. By repeating the image forming operation, toner stored in the toner storage portion 421 is gradually consumed.

As described above, the toner cartridge 42 is configured to be detachably attached to the process cartridge 41. When toner stored in the toner storage portion 421 runs out, the user separates the toner cartridge 42 being used up from the process cartridge 41, and replaces the old toner cartridge 42 with a new toner cartridge 42. Thereby, the user may continuously execute the image forming operation of the image forming apparatus 10. By repeatedly performing the image forming operation, the respective parts of the photosensitive drum 411 and the process cartridge 41 are gradually degraded. According to the present embodiment, the process cartridge 41 may be attached to and detached from to the apparatus body 1. Thereby, the user may execute the image forming operation by replacing the degraded process cartridge 41 with a new process cartridge 41.

### Operating Portion and Connecting Portion

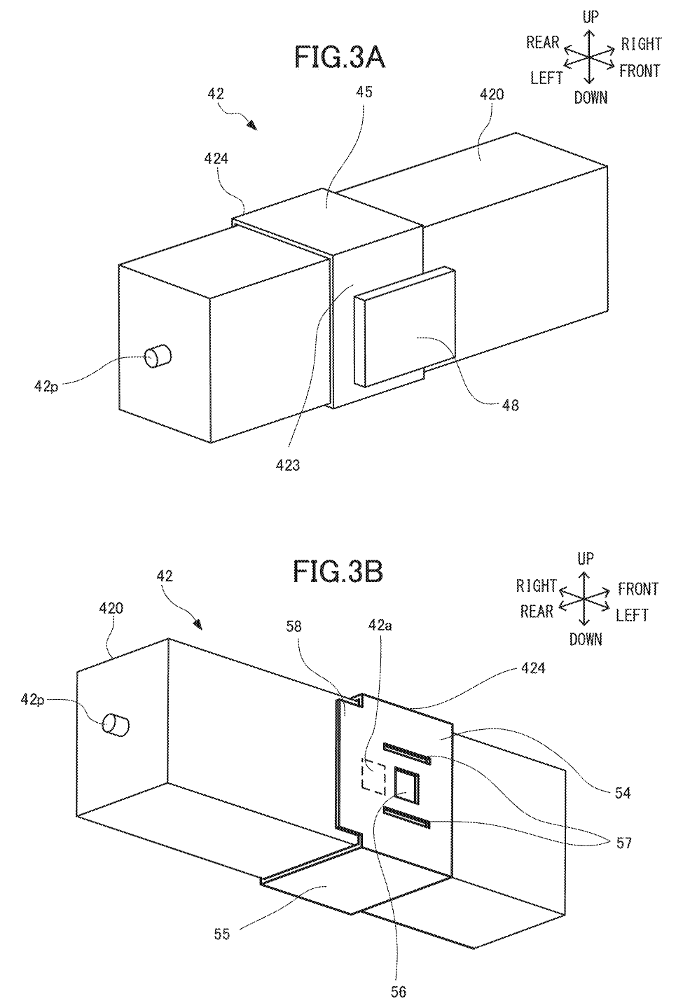

Next, the operating portion 423 and the connecting portion 424 according to the present embodiment will be described with reference to FIGS. 3A and 3B. FIG. 3A is a perspective view illustrating the toner cartridge 42 viewed from a front left direction. FIG. 3B is a perspective view illustrating the toner cartridge 42 viewed from a rear right direction. As illustrated in FIG. 3A, the toner cartridge 42 includes a casing 420, the operating portion 423, and the connecting portion 424. The casing 420 includes positioning pins 42p serving as an example of a second positioned portion. The positioning pins 42p are formed on each of side end surfaces on the left and right sides of the casing 420, as illustrated in FIGS. 3A and 3B. The positioning pins 42p are members that position the toner cartridge 42 to the attachment portion 415.

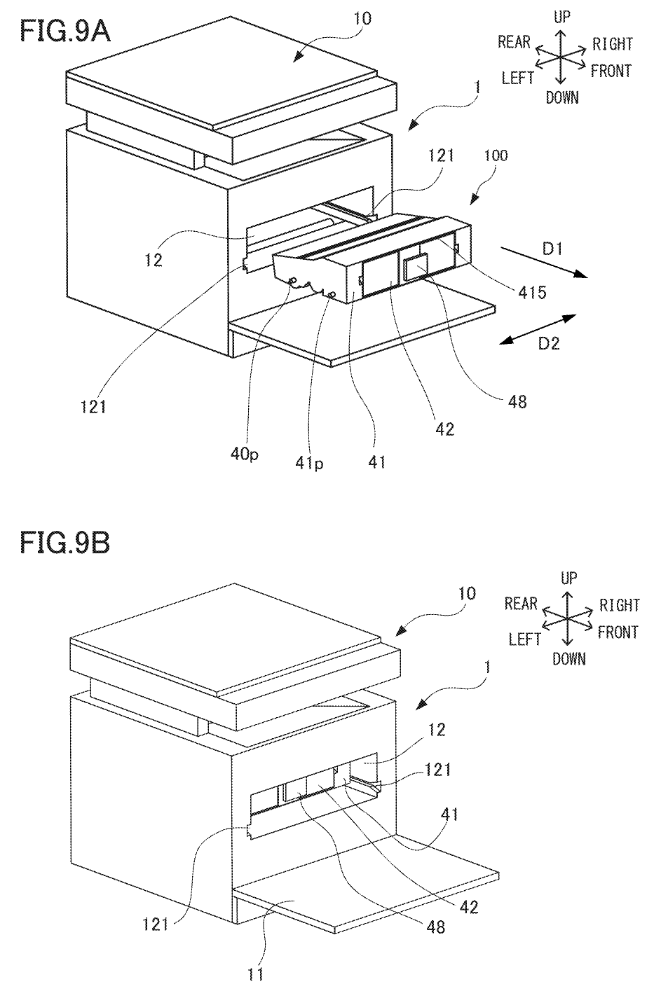

As illustrated in FIG. 3A, the operating portion 423 includes the holding portion 48 and a coupling portion 55. The operating portion 423 is supported in a linearly movable manner together with the outlet shutter 54 in a right-left direction, which is an example of a movement direction D2 (refer to FIG. 9A). The holding portion 48 is a portion held by the user. When moving the operating portion 423 in a right-left direction or when attaching or detaching the toner cartridge 42 or the process cartridge 41 to or from the apparatus body 1, the holding portion 48 is held. The coupling portion 55 is a portion for coupling the holding portion 48 and the connecting portion 424.

As illustrated in FIG. 3B, the toner cartridge 42 further includes the outlet 42a and the connecting portion 424. The outlet 42a is formed on the casing 420. The outlet 42a is an opening for discharging toner. The outlet 42a is communicated with the toner storage portion 421 and discharges toner stored in the toner storage portion 421.

The connecting portion 424 includes the outlet shutter 54, a communication outlet 56, engagement holes 57, and an engaging portion 58. The connecting portion 424 is coupled to the coupling portion 55, and is movable in an interlocked manner with the operating portion 423. The outlet shutter 54 is a portion for opening and closing the outlet 42a. The communication outlet 56 is an opening formed on the outlet shutter 54. When the positions of the communication outlet 56 and the outlet 42a correspond, the outlet 42a is opened, and discharge of toner is enabled. The engagement holes 57 are an example of a shutter engaging portion, and it is an engaging portion that engages with the inlet shutter 53. The engaging portion 58 is a portion that fixes the toner cartridge 42 to the attachment portion 415.

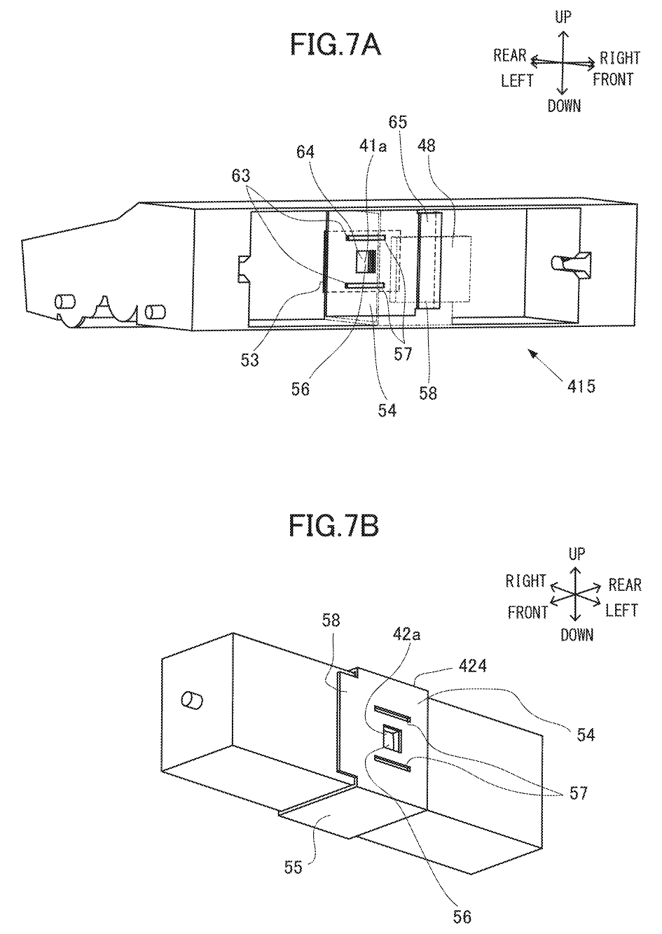

That is, the outlet shutter 54 is an example of a movement member, which is movable with respect to the toner storage portion 421 and on which the engaging portion 58 is provided. The outlet shutter 54 is movable with respect to the casing 420 and is disposed to be interlocked with a holding portion 48. In a state where the toner cartridge 42 is attached to the process cartridge 41, the outlet shutter 54 is positioned at a second opened position where the outlet 42a is opened when the holding portion 48 is positioned at a first position (refer to FIG. 7B). That is, a first position is a position where the engaging portion 58 is engaged with an engaged portion 65 such that the toner cartridge 42 is moved integrally with the process cartridge 41 when the toner cartridge 42 is moved in a detachment direction D1.

Further, in a state where the toner cartridge 42 is attached to the process cartridge 41, if the holding portion 48 is positioned at a second position, the outlet shutter 54 is positioned at a second closed position closing the outlet 42a (refer to FIG. 3B). That is, a second position is a position where the engaging portion 58 is not engaged with the engaged portion 65 such that the toner cartridge 42 is withdrawn from the process cartridge 41 and moved when the toner cartridge 42 is moved in the detachment direction D1. Further, according to the present embodiment, the outlet shutter 54 and the engaging portion 58 are arranged upstream of the casing 420 in a detaching direction, i.e., front direction. Therefore, these members may be integrated easily, by which the configuration may be simplified. In a case where the outlet shutter 54 and the engaging portion 58 are formed as individual members, the number of components is increased and costs will be increased. In contrast, according to the present embodiment, the outlet shutter 54 and the engaging portion 58 are integrated, such that the increase of number of components may be suppressed, and costs may be cut down.

### Attachment Portion

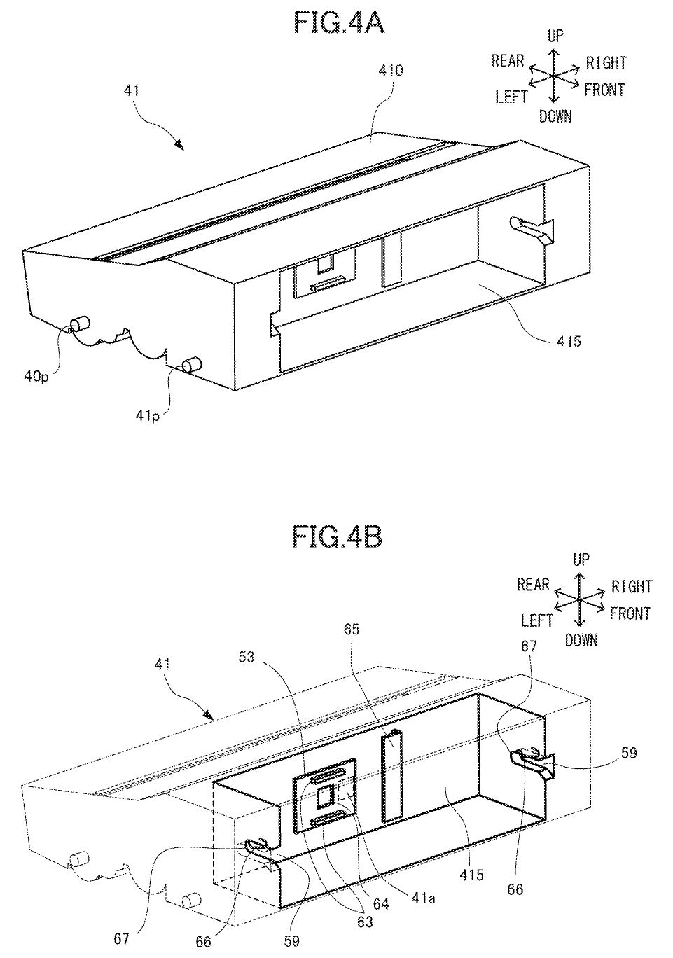

Next, the attachment portion 415 will be described with reference to FIGS. 4A and 4B. FIG. 4A is a perspective view illustrating an external appearance of the process cartridge 41. FIG. 4B is a perspective view illustrating the attachment portion 415. In the drawing, a visible outline of the process cartridge 41 is illustrated by a two-dot chain line, and the attachment portion 415 is illustrated by a solid line.

As illustrated in FIG. 4A, a positioning pin 40p and a guide pin 41p are disposed on a left end surface of the process cartridge 41. Although not shown, the positioning pin 40p and the guide pin 41p are also disposed on the right end surface of the process cartridge 41, similar to the left end surface. The positioning pins 40p are members for positioning the process cartridge 41 on the apparatus body 1. The guide pins 41p are an example of a first positioned portion, and they are portions for regulating the orientation of the process cartridge 41. Further, the attachment portion 415 is disposed on the front end side of the process cartridge 41.

As illustrated in FIG. 4B, the attachment portion 415 includes the inlet 41a, the inlet shutter 53, the engaged portion 65, and guides 59. The inlet 41a is an opening through which toner is received. Toner discharged from the toner cartridge 42 is received via the inlet 41a into the developing chamber 62. The inlet shutter 53 is a portion for opening and closing the inlet 41a. The inlet shutter 53 is supported movably in right and left directions. In the drawing, the inlet shutter 53 is in a state moved to a left side. In this state, the inlet shutter 53 closes the inlet 41a.

The inlet shutter 53 includes ribs 63 and a communication inlet 64. The ribs 63 are an example of a shutter engaged portion, and it is a portion that engages with the engagement holes 57. The inlet 41a is opened by having the communication inlet 64 match the inlet 41a. By having the communication inlet 64 communicate with the inlet 41a, reception of toner is enabled.

The engaged portion 65 is a portion that engages with the engaging portion 58, and that is fixed to the casing 410. The outlet shutter 54 moves, and the engaged portion 65 is engaged with the engaging portion 58. Thereby, the toner cartridge 42 and the process cartridge 41 are connected. If the engaged portion 65 and the engaging portion 58 are in a disengage position, the connection of the toner cartridge 42 is disengaged, and the toner cartridge 42 and the process cartridge 41 are separable.

The guides 59 are groove-shaped portions that are disposed on the inner walls on the right and left sides of the attachment portion 415. The guides 59 include urging springs 66, which are an example of a second urging portion, and positioning portions 67, which are an example of a second positioning portion. The guides 59 are portions that guide the toner cartridge 42 when attaching and detaching the toner cartridge 42 to and from the attachment portion 415. The positioning portions 67 are portions for positioning the toner cartridge 42 to the attachment portion 415. The positioning portions 67 and the positioning pins 42p are designed to fit to each other. By having the positioning portions 67 contact the positioning pins 42p and positioned thereby, the toner cartridge 42 may be positioned in a state attached to the process cartridge 41. The urging springs 66 are leaf springs that push the positioning pins 42p against the positioning portions 67. When the toner cartridge 42 is attached to the attachment portion 415, the positioning pins 42p fit to the positioning portions 67 and are pushed by the urging springs 66, such that they are appropriately positioned. That is, the urging springs 66 urge the positioning pins 42p to be in contact with the positioning portions 67.

That is, the inlet shutter 53 is disposed movably with respect to the casing 410 and also in an interlocked manner with the holding portion 48. In a state where the toner cartridge 42 is attached to the process cartridge 41, if the holding portion 48 is positioned at the first position, the inlet shutter 53 is positioned at a first opened position opening the inlet 41a (refer to FIG. 7A). In a state where the toner cartridge 42 is attached to the process cartridge 41, if the holding portion 48 is positioned at the second position, the inlet shutter 53 is positioned at a first closed position closing the inlet 41a (refer to FIG. 4B).

### Attachment and Detachment of Toner Cartridge

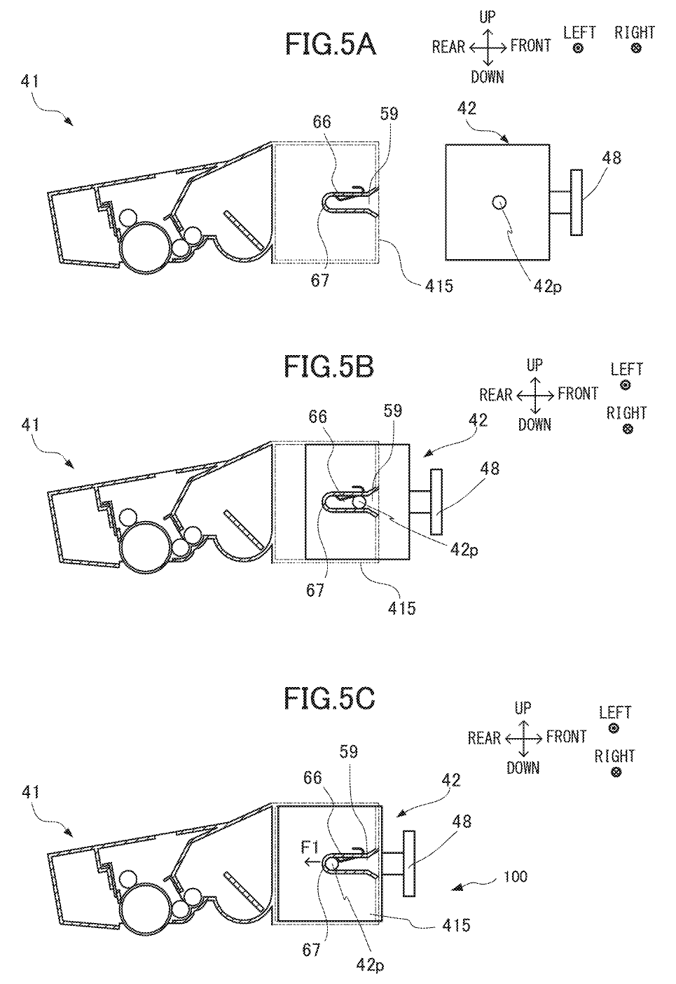

Next, with reference to FIGS. 5A - 5C, the state in which the toner cartridge 42 is attached to and detached from the attachment portion 415 of the process cartridge 41 will be described. FIGS. 5A -5C are schematic views illustrating a state in which the toner cartridge 42 is attached to and detached from the process cartridge 41. FIG. 5A illustrates a state in which the toner cartridge 42 is detached from the attachment portion 415. Hereafter, this state is referred to as the toner cartridge 42 and the process cartridge 41 being separated. FIG. 5B illustrates a state in which the toner cartridge 42 is in midway of being attached to the attachment portion 415. FIG. 5C illustrates a state in which the toner cartridge 42 is attached to the attachment portion 415. Hereafter, this state is referred to as the toner cartridge 42 and the process cartridge 41 being connected.

As illustrated in FIG. 5A, in order to attach the toner cartridge 42 to the attachment portion 415, the user holds the holding portion 48 so that it faces the front, and moves the toner cartridge 42 rearward toward the attachment portion 415 such that the positioning pins 42p and the guides 59 correspond. That is, the direction of attachment of the toner cartridge 42 is the rear direction. When the toner cartridge 42 is moved further rearward, as illustrated in FIG. 5B, the positioning pins 42p engage with the guides 59, and the toner cartridge 42 moves rearward in the interior of the attachment portion 415 in a state guided by the guides 59. When the toner cartridge 42 is moved further rearward, the positioning pins 42p move beyond the urging springs 66, and as illustrated in FIG. 5C, the positioning pins 42p are engaged with and are positioned by the positioning portions 67. In this state, the positioning pins 42p are urged toward the rear side by the urging springs 66 beyond which they have moved. Therefore, the toner cartridge 42 is appropriately positioned and attached by the attachment portion 415. In order to remove the toner cartridge 42 from the attachment portion 415, a reverse operation should be performed in the order of FIGS. 5C, 5B, and 5A, by which the positioning pins 42p are moved toward the front side beyond the urging springs 66, and are guided by the guides 59.

In the present embodiment, an attachment/detachment direction in which the user attaches/detaches the toner cartridge 42 to/from the process cartridge 41 is referred to as a first direction, and especially, the direction in which the user removes the toner cartridge 42 from the process cartridge 41 is referred to as the detachment direction D1. That is, the first direction includes an attachment direction in which the toner cartridge 42 is attached to the process cartridge 41, and the detachment direction D1 in which the toner cartridge 42 is detached from the process cartridge 41. In the present embodiment, the attachment/detachment direction is the front-rear direction, and the detachment direction D1 of the toner cartridge 42 is the front direction (refer to FIG. 9A). Further, the movement direction D2 of moving the holding portion 48 and the outlet shutter 54 is one example of a second direction, and it intersects with the attachment/detachment direction. In the present embodiment, the movement direction D2 and the detachment direction D1 are orthogonal. Further according to the present embodiment, in a state where the cartridge 100 takes an orientation of attachment to the apparatus body 1, the movement direction D2 is a direction that intersects a gravity direction.

### Operations of Outlet Shutter and Inlet Shutter

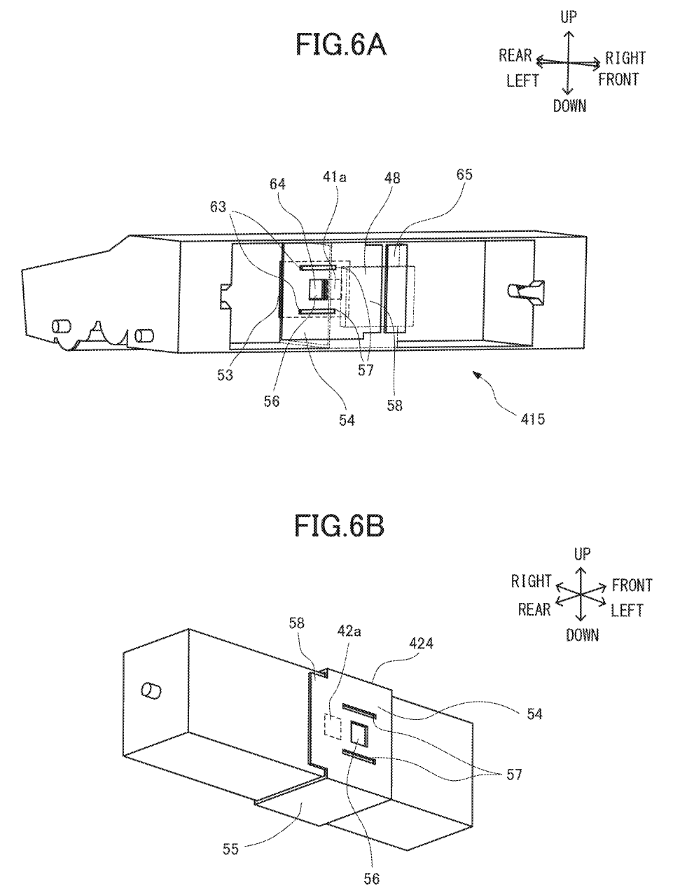

Next, operations of the outlet shutter 54 and the inlet shutter 53 will be described with reference to FIGS. 6A - 7B. FIGS. 6A - 7B are perspective views illustrating the attachment portion 415 and the connecting portion 424. FIGS. 6A and 6B illustrate a state in which the engagement of the engaged portion 65 and the engaging portion 58 is released. FIGS. 7A and 7B illustrate a state in which the engaged portion 65 and the engaging portion 58 are engaged. FIG. 6A is a perspective view illustrating the attachment portion 415 from a front left side. In the drawing, the shape of the holding portion 48 and a circumference area thereof is illustrated by a two-dot chain line. FIG. 6B is a perspective view illustrating the connecting portion 424. FIG. 6A is a perspective view illustrated from the front left side, and FIG. 6B is a perspective view illustrated from the rear right side.

As illustrated in FIG. 6A, in a state where the toner cartridge 42 is attached to the attachment portion 415, the engagement holes 57 are engaged with the ribs 63. That is, the ribs 63 are engaged with the engagement holes 57 when the toner cartridge 42 is attached to the process cartridge 41, and causes the outlet shutter 54 to be interlocked with the inlet shutter 53. Therefore, when the holding portion 48 is moved in the right and left directions, the outlet shutter 54 and the inlet shutter 53 are interlocked and move in the right and left directions. As illustrated in the drawing, when the holding portion 48 is at the left side, the inlet 41a is closed by the inlet shutter 53. In this state, as illustrated in FIG. 6B, the outlet shutter 54 moves to the left side and closes the outlet 42a. Hereafter, this state is referred to as the inlet shutter 53 and the outlet shutter 54 being in a closure position. Further, as illustrated in FIG. 6A, the engagement between the engaged portion 65 and the engaging portion 58 is released. Hereafter, this state is referred to as the engaging portion 58 being in a disengaged position. That is, the disengaged position is a position in which the engagement with the engaged portion 65 is disengaged and removal of the toner cartridge 42 from the process cartridge 41 is permitted. Further, the position of the holding portion 48 in which the engaging portion 58 is positioned at the disengaged position and the inlet shutter 53 and the outlet shutter 54 are at the closure position is hereinafter referred to as a second position.

FIG. 7A is a perspective view illustrating the attachment portion 415 from a front left side. In the drawing, the shape of the holding portion 48 and a circumference area thereof is illustrated by a two-dot chain line. FIG. 7B is a perspective view illustrating the connecting portion 424. FIG. 7A is a perspective view illustrated from the front left side, and FIG. 7B is a perspective view illustrated from the rear right side. As illustrated in FIG. 7A, in a state where the holding portion 48 is at the right side, the inlet shutter 53 opens the inlet 41a. In this state, as illustrated in FIG. 7B, the outlet shutter 54 moves to the right side and opens the outlet 42a. Hereafter, this state is referred to as the inlet shutter 53 and the outlet shutter 54 being in an open position. Further, as illustrated in FIG. 7A, the engaged portion 65 and the engaging portion 58 are engaged. Hereafter, this state is referred to as the engaging portion 58 being in an engaged position. That is, the engaged position is a position at which, in a state where the toner cartridge 42 is attached to the process cartridge 41, the engaged portion 65 is engaged and removal of the toner cartridge 42 from the process cartridge 41 is regulated. Further, the position of the holding portion 48 in a state where the engaging portion 58 is at the engaged position and the inlet shutter 53 and the outlet shutter 54 are at the open position are hereinafter referred to as the first position.

That is, the holding portion 48 is interlocked with the engaging portion 58 and movable in the movement direction D2 between the first position where the engaging portion 58 is positioned in the engaged position and the second position where the engaging portion 58 is positioned at the disengaged position. In the present embodiment, the holding portion 48 is disposed on a downstream end portion of the casing 420 in the detaching direction, i.e., front direction. Therefore, the user may easily access the holding portion 48 from a front side of the apparatus body 1. Further, by the holding portion 48 moving from the second position to the first position, the casing 410 and the casing 420 are communicated via the outlet 42a and the inlet 41a. By the holding portion 48 moving from the first position to the second position, the communication of the casing 410 and the casing 420 is blocked.

As described above, in a state where the holding portion 48 is at the first position, the engaging portion 58 is moved to a fixing position. Thereby, the toner cartridge 42 and the process cartridge 41 are connected. In this state, since the outlet shutter 54 and the inlet shutter 53 are in the open position, the outlet 42a and the inlet 41a are opened. Therefore, toner stored in the toner cartridge 42 may be conveyed to the process cartridge 41.

Further, in a state where the holding portion 48 is at the second position, the engaging portion 58 moves to the disengaged position. Therefore, the connection between the toner cartridge 42 and the process cartridge 41 is disengaged, and they may be separated. In this state, the outlet shutter 54 and the inlet shutter 53 are in the closure position, such that the outlet 42a and the inlet 41a are closed. Therefore, even if the toner cartridge 42 and the process cartridge 41 are separated, toner is suppressed from leaking to the exterior.

In the present embodiment, the respective shutters of the toner cartridge 42 and the process cartridge 41 are designed such that they may be directly engaged with each other. Further, the engagement holes 57, which are the engaging portions of the inlet shutter 53, are formed to have recess shapes, and the ribs 63, which are the engaging portions of the outlet shutter 54, are formed to have protruded shapes. By adopting such shapes, as illustrated in FIG. 6B, the connecting portion 424 of the toner cartridge 42 will not have projected portions. Since there are no projected portions formed on the connecting portion 424 of the toner cartridge 42, the package box of the toner cartridge 42 may be downsized. Meanwhile, as illustrated in FIG. 6A, the ribs 63 are disposed on the inner side of the attachment portion 415. Therefore, even if the ribs 63 have projected shapes, the size of the package box will not be affected.

Furter, as illustrated in FIGS. 6A -7B, the outlet shutter 54 and the engaging portion 58 are arranged on the same side surface. Further, the inlet shutter 53 and the engaged portion 65 are arranged on the same side surface facing the outlet shutter 54 and the engaging portion 58. By adopting such an arrangement, the outlet shutter 54 and the engaging portion 58 may be integrated. By integration, it may be possible to cut down component costs and assembly costs.

### Attachment and Detachment of Process Cartridge

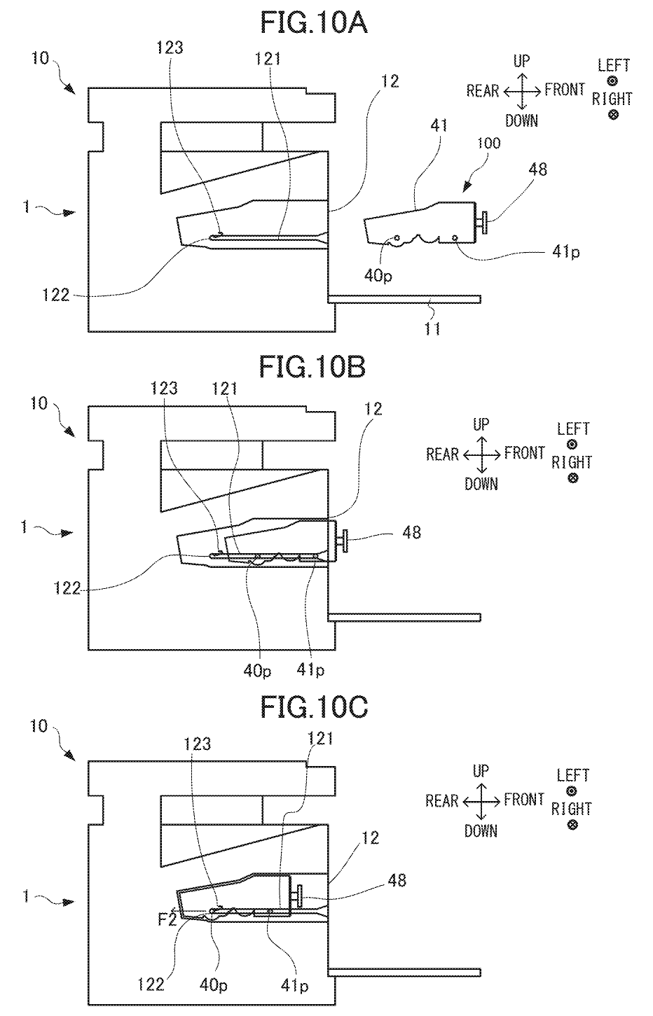

Next, the attachment and detachment of the process cartridge 41 will be described with reference to FIGS. 8A - 10C. FIGS. 8A - 8C are views illustrating the external appearance of the apparatus body 1, and the front cover 11 and a cartridge opening 12. FIGS. 9A and 9B are perspective views of the state in which the process cartridge 41 is attached to and detached from the apparatus body 1. FIGS. 10A -10C are schematic views illustrating a state in which the process cartridge 41 is attached to and detached from the apparatus body 1.

The apparatus body 1 includes the front cover 11, which is arranged on a downstream side of the apparatus body 1 in a front direction, which is a discharging direction, and that opens and closes the cartridge opening 12 through which the cartridge 100 passes when attaching and detaching the cartridge to and from the apparatus body 1. The front cover 11 is an example of a door. In an opened state, the front cover 11 is configured to allow the toner cartridge 42 and the process cartridge 41 to be integrally attached to and detached from the apparatus body 1 through the cartridge opening 12. Further, in the open state, the front cover 11 is configured to allow the toner cartridge 42 to be attached to and detached from the process cartridge 41 via the cartridge opening 12. In the state where the cartridge opening 12 is closed, the front cover 11 constitutes an exterior surface of the image forming apparatus 10. Further, in a state where the process cartridge 41 is attached to the apparatus body 1 and the toner cartridge 42 is attached to the process cartridge 41, the front cover 11 is configured to enable the cartridge opening 12 to be closed without interfering with the cartridge 100. Further, in a state where the process cartridge 41 is attached to the apparatus body 1 and the toner cartridge 42 is attached to the process cartridge 41, the toner cartridge 42 is configured to be inserted to the apparatus body 1 and not exposed to the outer side of the image forming apparatus 10.

FIG. 8A is a perspective view illustrating a state in which the front cover 11 is closed. FIG. 8B is a perspective view in which the front cover 11 is opened and the cartridge opening 12 is exposed. FIG. 8C is a perspective view illustrating an inner side of the cartridge opening 12. As illustrated in FIG. 8A, the apparatus body 1 includes the front cover 11 disposed on the front side. The front cover 11 is a cartridge cover. The front cover 11 is supported in an openable and closable manner. In the drawing, the front cover 11 is in a state closing the cartridge opening 12. As illustrated in FIG. 8B, when the front cover 11 is opened, the cartridge opening 12 is exposed. The cartridge opening 12 is an opening through which the process cartridge 41 or the toner cartridge 42 may be attached and detached. In the present embodiment, the process cartridge 41 or the toner cartridge 42 may be detached in a direction along a horizontal direction with respect to the apparatus body 1 and in a detaching direction, i.e., front direction.

As illustrated in FIG. 8C, the cartridge opening 12 includes guides 121, positioning portions 122, and urging springs 123. The guides 121 are groove-shaped portions formed on right and left inner walls of the cartridge opening 12, and which are guide portions for attaching and detaching the process cartridge 41 to and from the apparatus body 1. The positioning portions 122 are portions formed at the rear ends of the guides 121, and which are portions for positioning the process cartridge 41 to the apparatus body 1. The positioning portions 122 are an example of a first positioning portion, coming into contact with and positioning the guide pins 41p, by which the process cartridge 41 is positioned in a state attached to the apparatus body 1. The urging springs 123 are elastic members assembled to the positioning portions 122, and which are pushing members when the process cartridge 41 is positioned at the positioning portions 122. The urging springs 123 are an example of a first urging portion, urging the guide pins 41p to come into contact with the positioning portions 122. The guides 121 and the positioning portions 122 are designed to fit the positioning pins 40p. By the positioning pins 40p fitting to the positioning portions 122, the process cartridge 41 is positioned appropriately on the apparatus body 1.

FIG. 9A illustrates a state in which the process cartridge 41 is positioned outside the apparatus body 1. FIG. 9B illustrates a state in which the process cartridge 41 is attached to the apparatus body 1. As illustrated in FIGS. 9A and 9B, when attaching and detaching the process cartridge 41 to and from the apparatus body 1, the process cartridge 41 is in a state where the toner cartridge 42 is connected thereto. As illustrated in FIG. 9A, when attaching the process cartridge 41 to the apparatus body 1, the holding portion 48 is positioned at the front side. Next, the positioning pins 40p are moved to the rear direction toward the cartridge opening 12. Then, the positions of the positioning pins 40p and the guides 121 are matched, and the process cartridge 41 is moved rearward and into the cartridge opening 12.

As illustrated in FIG. 9A, when the process cartridge 41 is attached to the apparatus body 1 and the toner cartridge 42 is attached to the process cartridge 41, the entire body of the toner cartridge 42 is stored in the inner side of the apparatus body 1. When the process cartridge 41 is attached to the apparatus body 1, the holding portion 48 is exposed on the front side of the cartridge opening 12. When taking the process cartridge 41 and the toner cartridge 42 out of the apparatus body 1, the holding portion 48 may be held for removal. Further, when attaching and detaching the process cartridge 41 to and from the apparatus body 1, the holding portion 48 is moved to the first position.

FIG. 10A illustrates a state in which the process cartridge 41 is outside the apparatus body 1. FIG. 10B illustrates a state in which the process cartridge 41 is in midway of being attached to and detached from the apparatus body 1. FIG. 10C illustrates a state in which the process cartridge 41 is attached to the apparatus body 1. As illustrated in FIG. 10A, when attaching the process cartridge 41 to the apparatus body 1, the user directs the positioning pins 40p toward the cartridge opening 12. Next, the user matches the positions of the positioning pins 40p and the guides 121 while moving the process cartridge 41 rearward. The user inserts the process cartridge 41 in this state to the cartridge opening 12.

As illustrated in FIG. 10B, by moving the positioning pins 40p and the guide pins 41p along the guides 121, the user may regulate the movement locus of the process cartridge 41. Further, the orientation of the process cartridge 41 during movement is stabilized. When the user moves the process cartridge 41 rearward in this state, the positioning pins 40p push up and move beyond the urging springs 123.

As illustrated in FIG. 10C, the positioning pins 40p move to the positioning portions 122. In this state, since the positioning pins 40p and the positioning portions 122 are designed to fit to each other, the process cartridge 41 is appropriately positioned on the apparatus body 1. As illustrated in the drawing, the urging springs 123 are designed to push the positioning pins 40p rearward. Therefore, the positioning pins 40p are pushed by the positioning portions 122. Based on this operation, the process cartridge 41 is appropriately positioned on the apparatus body 1.

The attachment and detachment of the process cartridge 41 to and from the apparatus body 1 may be executed, for example, when a sheet S is jammed in the interior of the apparatus body 1, i.e., when jamming has occurred. When jamming occurs, the user opens the front cover 11. Next, the user draws out the process cartridge 41 to the exterior of the apparatus body 1. The user removes the sheet S that has been retained inside the apparatus body 1, then attaches the process cartridge 41 to the apparatus body 1, and closes the front cover 11. Further, when the process cartridge 41 has reached its life, the user may replace the process cartridge 41 that has reached its life with a new process cartridge 41. At this time, the process cartridge is drawn out of the apparatus body 1 in a state where the toner cartridge 42 is connected thereto. In this state, if toner still remains in the toner cartridge 42 being used, the toner cartridge 42 being used may be attached to the new process cartridge 41, which is then attached to the apparatus body 1.

### Method for Switching Cartridge to be Drawn Out

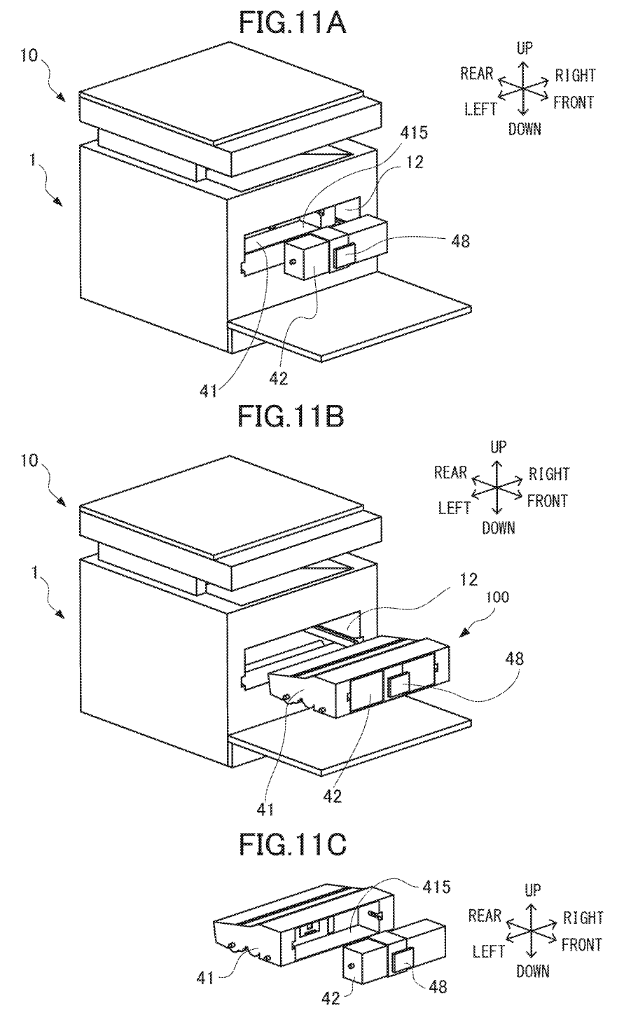

Next, a method for switching the cartridge to be drawn out of the apparatus body 1 will be described with reference to FIGS. 5A - 5C, FIGS. 9A and 9B, and FIGS 11A - 11C. FIGS. 11A -11C are perspective views illustrating a method for switching cartridges to be drawn out of the apparatus body 1. FIG. 11A illustrates a state in which the toner cartridge 42 is drawn out alone from the apparatus body 1. FIG. 11B illustrates a state in which the process cartridge 41 having the toner cartridge 42 connected thereto is drawn out of the apparatus body 1. FIG. 11C illustrates a state in which the toner cartridge 42 is separated from the process cartridge 41.

As illustrated in FIGS. 5A- 5C, the urging springs 66 push the toner cartridge 42 toward an attaching direction, i.e., front direction, by a pushing force F1, i.e., urging force. As illustrated in FIG. 10C, the urging springs 123 push the process cartridge 41 toward the attaching direction, i.e., front direction, by a pushing force F2, i.e., urging force. The respective pushing forces are set to satisfy F1 < F2.

As illustrated in FIG. 11A, in a state where the holding portion 48 is moved from the first position to the second position, the connection between the toner cartridge 42 and the process cartridge 41 is disengaged, and the holding portion 48 is drawn toward the front direction, the toner cartridge 42 may be drawn out alone from the apparatus body 1. As described above, since F1 < F2 is satisfied, when the engagement between the engaged portion 65 and the engaging portion 58 is released, the toner cartridge 42 may be drawn out alone while having the process cartridge 41 remain attached to the apparatus body 1. That is, by having the user operate the holding portion 48 to maintain the second position while moving to the detachment direction D1, i.e., front direction, intersecting the movement direction D2, i.e., right-left direction, the toner cartridge 42 may be removed from the process cartridge 41. In this state, since the outlet 42a and the inlet 41a are closed by the outlet shutter 54 and the inlet shutter 53, toner may be suppressed from leaking to the exterior.

Further, when attaching the toner cartridge 42 again to the process cartridge 41, a reverse operation should be performed. After attachment, by moving the holding portion 48 from the second position to the first position, the toner cartridge 42 and the process cartridge 41 are connected. Further, since the outlet shutter 54 and the inlet shutter 53 are moved to the open position of the outlet 42a and the inlet 41a, toner stored in the toner cartridge 42 may be conveyed to the process cartridge 41. As illustrated in FIG. 11B, in a state where the holding portion 48 is at the first position, when the holding portion 48 is drawn out to the front direction, the toner cartridge 42 and the process cartridge 41 may be drawn out of the apparatus body 1 in a connected state. That is, by having the user operate the holding portion 48 in the detachment direction D1 while maintaining the first position, the process cartridge 41 and the toner cartridge 42 nay be moved to the detaching direction with respect to the apparatus body 1.

When replacing the process cartridge 41 with a new one, the user draws out the cartridge 100 from the apparatus body 1 in a state where the toner cartridge 42 and the process cartridge 41 are connected, and separates the toner cartridge 42 from the process cartridge 41. As illustrated in FIG. 11C, the user moves the holding portion 48 from the first position to the second position of the cartridge 100 being removed, and moves the toner cartridge 42 toward the removal direction from the process cartridge 41 to remove the same. Then, after replacing the process cartridge 41 with a new process cartridge, the user attaches the toner cartridge 42 that has been used to the attachment portion 415. Further, by moving the holding portion 48 to the first position, the user connects the cartridges together, and attaches the cartridge 100 to the apparatus body 1 to complete the replacement operation.

### Display of Cartridge to be Drawn Out

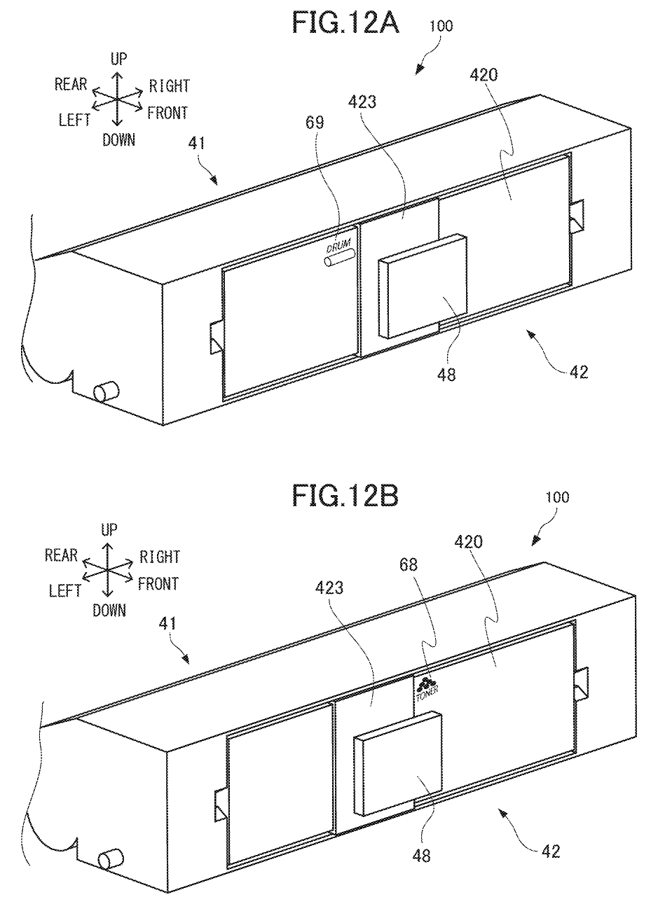

Next, a display of the cartridge to be drawn out will be described with reference to FIGS. 12A and 12B. FIGS. 12A and 12B are magnified perspective views illustrating the portion of the process cartridge 41 to which the toner cartridge 42 is connected. FIG. 12A illustrates a state in which the holding portion 48 is positioned at the first position. FIG. 12B illustrates a state in which the holding portion 48 is positioned at the second position. In this example, the operating portion 423 is an example of a cover portion, which is disposed movably with respect to the casing 420 and which is interlocked with the holding portion 48 and the engaging portion 58.

As illustrated in FIG. 12A, the casing 420 includes a drum icon 69, which is a notification sign notifying the cartridge to be attached and detached. The drum icon 69 is disposed on a left side of the operating portion 423. In a state where the holding portion 48 is at a first position, it is moved to a right side in the drawing. That is, the drum icon 69 is an example of a first display portion, and when the holding portion 48 is positioned at a second position, the drum icon 69 is covered by the operating portion 423, whereas when the holding portion 48 is positioned at a first position, it is exposed from the operating portion 423. Thereby, the drum icon 69 indicates that the removal of the toner cartridge 42 from the process cartridge 41 is regulated.

As illustrated in FIG. 12B, the casing 420 includes a toner icon 68 which is a notification sign of the cartridge to be attached and detached. The toner icon 68 is disposed on a right side of the operating portion 423. In a state where the holding portion 48 is at a second position, it is moved to a left side in the drawing. That is, the toner icon 68 is an example of a second display portion, and when the holding portion 48 is positioned at a first position, it is covered by the operating portion 423, whereas when the holding portion 48 is positioned at a second position, it is exposed from the operating portion 423. Thereby, the toner icon 68 indicates that the removal of the toner cartridge 42 from the process cartridge 41 is permitted.

As illustrated in FIG. 12A, in a state where the holding portion 48 is at a first position, the operating portion 423 is moved to the right side. In this state, the toner icon 68 on the right side of the operating portion 423 is covered by the operating portion 423. Therefore, the toner icon 68 may not be visually confirmed. Meanwhile, in a state where the holding portion 48 is at the first position, the drum icon 69, which is the first display, may be visually confirmed. That is, in a state where the holding portion 48 is at the first position, the drum icon 69 may be visually confirmed, such that the user may be notified that the toner cartridge 42 and the process cartridge 41 are in a connected state and detachably attached to the apparatus body 1.

As illustrated in FIG. 12B, in a state where the holding portion 48 is at a second position, the operating portion 423 is moved to the left side. In this state, the drum icon 69 on the left side of the operating portion 423 is covered by the operating portion 423. Therefore, the drum icon 69 may not be visually confirmed. Meanwhile, in a state where the holding portion 48 is at the second position, the toner icon 68, which is the second display, may be visually confirmed. That is, in a state where the holding portion 48 is at the second position, the toner icon 68 may be visually confirmed, such that the user may be notified that the toner cartridge 42 is in an attachable-detachable manner.

As described above, in a state where the position of the holding portion 48 is the first position, the drum icon 69, which indicates that the toner cartridge 42 and the process cartridge 41 may be attached to and detached from the apparatus body 1 in the connected state, is displayed. Further, in a state where the position of the holding portion 48 is the second position, the toner icon 68, which indicates that the connection of the toner cartridge 42 and the process cartridge 41 is disengaged and the toner cartridge 42 may be attached and detached alone, is displayed. Thus, by switching the display according to the position of the holding portion 48, the user may be notified of which cartridge may be attached and detached when performing the attachment and detachment operation.

As described above, according to the cartridge 100 of the present embodiment, in a state where the toner cartridge 42 is attached to the process cartridge 41 and the holding portion 48 is positioned at the second position, the toner cartridge 42 may be detached from the process cartridge 41 by operating the holding portion 48 in the detachment direction D1 while maintaining the second position. Further, in a state where the toner cartridge 42 is attached to the process cartridge 41 and the holding portion 48 is positioned at the first position, the process cartridge 41 and the toner cartridge 42 may be moved integrally to the detaching direction with respect to the apparatus body 1 by operating the holding portion 48 in the detaching direction while maintaining the first position. That is, according to the cartridge 100 of the present embodiment, it becomes possible to provide an image forming apparatus 10 having a simple usability of enabling the operation for attaching and detaching the toner cartridge 42 and the process cartridge 41 to be performed by operating the holding portion 48. In further detail, all the operations including the switching operation of switching cartridges to be replaced, the operation of opening and closing the shutters performed therewith, and the operation for attaching and detaching the cartridge to and from the opening may be performed by operating the holding portion 48. Thereby, the switching operation for switching cartridges to be removed and the operation of attaching and detaching the cartridge being the target of replacement selected by the switching operation may be executed using the same member, which is the holding portion 48, such that the discomfort of the user may be solved and the operability may be improved.

Further, according to the cartridge 100 of the present embodiment, in a state where toner stored in the toner cartridge 42 has been consumed, the toner cartridge 42 may be replaced while the process cartridge 41 remains attached to the apparatus body 1. The toner cartridge 42 is smaller and has lighter weight than the process cartridge 41. Therefore, it is easier to handle the toner cartridge alone compared to attaching and detaching the toner cartridge 42 and the process cartridge 41 in the connected state to and from the apparatus body 1.

Further, according to the cartridge 100 of the present embodiment, the attachment/detachment direction of the toner cartridge 42 is the front-rear direction. Meanwhile, the direction in which the holding portion 48 is moved to connect and disconnect the process cartridge 41 and the toner cartridge 42 is the right-left direction. As described, by varying the attachment/detachment direction of each cartridge and the movement direction of the toner holding portion, erroneous operation may be prevented.

Further, as illustrated in FIGS. 11A - 11C, the front cover 11 and the cartridge opening 12 are arranged on the front side of the apparatus body 1. This surface is a side surface of the apparatus body 1, and it is a side surface of the side orthogonal to the axis of the photosensitive drum 411. The front cover 11 may be opened and closed without any problem even if sheets S are supported on the supporting portion 7. Further, the front cover 11 may be opened and closed without moving the document reading unit 8.

The cartridge opening 12 is an opening for attaching and detaching the toner cartridge 42 alone. Further, the cartridge opening 12 is an opening for attaching and detaching the process cartridge 41 having the toner cartridge 42 connected thereto to and from the apparatus body 1. The user may start the operation of attaching and detaching these cartridges by executing a step of opening the front cover 11 when attaching and detaching the toner cartridge 42 or the process cartridge 41 to the apparatus body 1. Then, by moving the holding portion 48 to the first position or the second position, the cartridge to be attached and detached may be selected.

Further, when performing the attachment and detachment operation of the toner cartridge 42 or performing the attachment and detachment operation of the process cartridge 41, the user always holds the holding portion 48. More specifically, the user accesses the holding portion 48 when performing both of the following operations, a switching operation to switch the cartridges to be attached and detached and an attachment and detachment operation to select the cartridge to be attached to and detached from the apparatus body 1. Thereby, when the user operates the cartridge 100, the user simply needs to remember the operation of accessing the holding portion 48 first, such that the operation may be simplified.

### Modified Example of First Embodiment

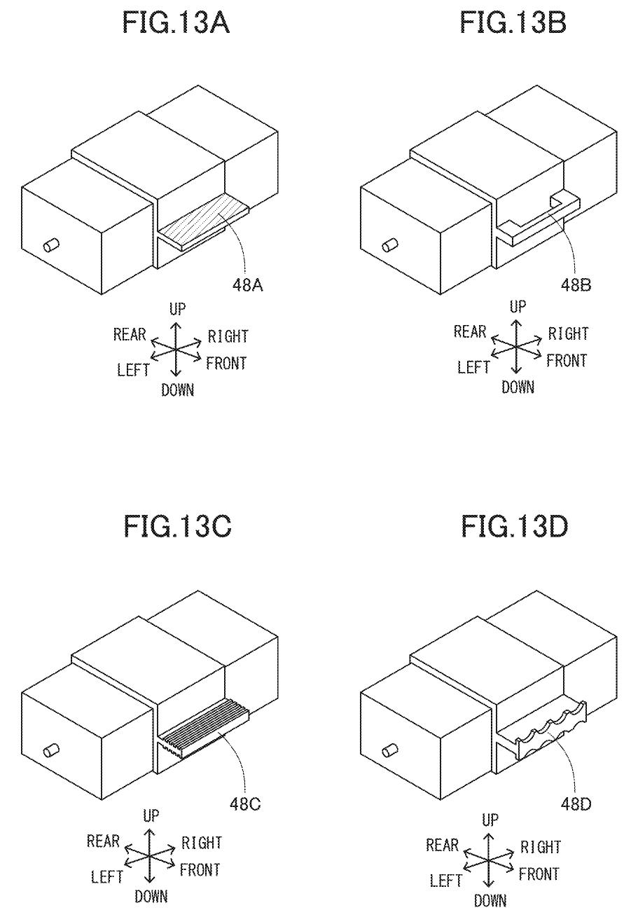

According to the embodiment described above, an example has been described of a case where the holding portion 48 has a plate-like shape in which the front-rear direction is the planar direction, but the present embodiment is not limited thereto. As described according to the present embodiment, the holding portion 48 is the portion that the user operates first when performing the switching operation of the cartridge 100 to be attached to and detached from the apparatus body 1 or for carrying out the attachment and detachment operation. Therefore, it is preferable that the holding portion 48 has a high visibility and that it is easy to hold. Therefore, the holding portion 48 may adopt shapes, for example, as illustrated in FIGS. 13A -13D.

FIG. 13A has an embossing provided on a holding portion 48A. Visibility may be improved by providing embossing. Further, slipping may be reduced by providing embossing. Visibility may be improved by applying a coating on the holding portion 48A. Further, slipping may be reduced by selecting an anti-slip coating having an aggregate added to a coating material. Further, by providing a two-color shaping using elastomer, it is possible to realize both improvement of visibility and reduction of slipping.

As illustrated in FIG. 13B, it may be possible to provide a space between a holding portion 48B and the coupling portion 55. Thereby, the visibility nay be improved. Moreover, by putting a finger into this space, the holding portion 48 may be held firmly. As illustrated in FIG. 13C, it may be possible to provide multiple ribs on a holding portion 48C. Thereby, the visibility may be improved. By holding the multiple ribs, slipping may be reduced.

As illustrated in FIG. 13D, a wavy rib shape may be formed on a holding portion 48D. Thereby, visibility may be improved. Further, the wavy shape has an effect to guide the user to put his/her fingers therein. By holding the wavey shape with his/her fingers, the user may hold the holding portion 48D firmly. It is also possible to combine the above-mentioned shapes or adopt other shapes.

### Second Embodiment

Next, a second embodiment according to the present disclosure will be described. The second embodiment is composed by varying the mechanism of the operating portion 423 of the first embodiment. Therefore, configurations similar to the first embodiment are either not shown or denoted with the same reference numbers.

In the first embodiment, an example has been described of a configuration where the holding portion 48 is moved in the right-left direction. In the embodiment, the first position is where the holding portion 48 has moved to the right side, where the toner cartridge 42 and the process cartridge 41 are connected. The second position is where the holding portion 48 has moved to the left side, where the toner cartridge 42 and the process cartridge 41 are separable.

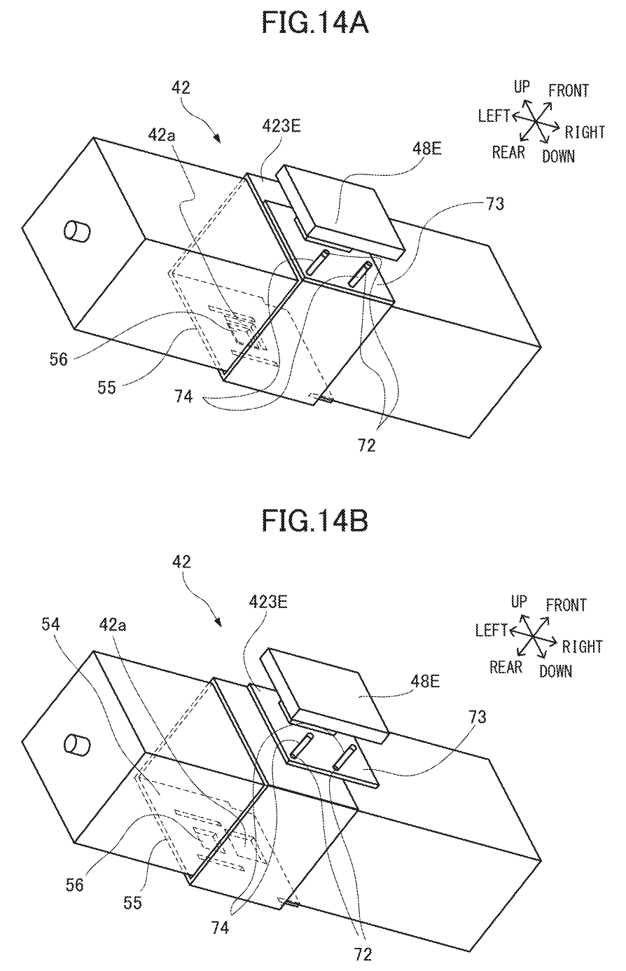

An operating portion 423E according to the present embodiment will be described with reference to FIGS. 6B, 7B, 14A and 14B. FIGS. 14A and 14B are perspective views illustrating the operating portion 423E according to the present embodiment. FIG. 14A illustrates a state where a holding portion 48E is at a first position. In the present configuration, the connecting portion 424 adopts the same configuration as FIG. 7B, such that descriptions thereof are omitted. FIG. 14B illustrates a state where the holding portion 48E is at a second position. In the present configuration, the connecting portion 424 adopts the same configuration as FIG. 6B, such that descriptions thereof are omitted.

As illustrated in FIG. 14A, the operating portion 423E includes the holding portion 48E, the coupling portion 55, cam followers 72, a cam plate 73, and cams 74. The cam followers 72 are bosses formed on the coupling portion 55. The cams 74 are grooves formed on the cam plate 73. The cam followers 72 are engaged with the cams 74. Further, the cam plate 73 is assembled to the holding portion 48E. Further, the holding portion 48E is supported movably only in the up-down direction by a mechanism not shown, and in the drawing, the holding portion 48E is positioned at a lower side. In this state, the operating portion 423E is moved to the right side, such that the outlet 42a and the communication outlet 56 correspond. Further, as illustrated in FIG. 7B, the engaging portion 58 is moved to the right side, such that it is engaged with the engaged portion 65.

As illustrated in FIG. 14B, when the holding portion 48E is moved to the upper side, the cam plate 73 also moves to the upper side. As illustrated in the drawing, the cams 74 are formed obliquely. Therefore, the cam followers 72 that engage with the cams 74 move to the left side. The cam followers 72 are portions formed on the coupling portion 55, such that the coupling portion 55 moves to the left side. Then, as illustrated in the drawing, the outlet 42a is closed by the outlet shutter 54. As described, as illustrated in FIG. 6B, the engaging portion 58 moves to the left side, such that the engagement with the engaged portion 65 is disengaged.

As described above, according to the present embodiment, the holding portion 48E is set to move in the up-down direction. When the holding portion 48E is at the lower side, the outlet 42a is opened, and the engaging portion 58 is at the engaged position. That is, when the holding portion 48E is at the lower side, the first position is taken. Meanwhile, when the holding portion 48E is at the upper side, the outlet 42a is closed, and the engaging portion 58 is at the disengaged position. That is, when the holding portion 48E is at the upper side, the second position is taken.

In the present embodiment, the attachment and detachment of the cartridge 100 to and from the apparatus body 1 is performed through the cartridge opening 12, similar to the first embodiment. Further, the attachment/detachment direction of the cartridge 100 to the apparatus body 1 is the front-rear direction. Therefore, the attachment/detachment direction of the toner cartridge 42 and the process cartridge 41 and the direction of movement of the holding portion 48E for selecting the cartridge to be attached and detached are approximately perpendicular directions.

### Third Embodiment

Next, a third embodiment according to the present disclosure will be described. The third embodiment is composed by varying the mechanism of the operating portion 423 of the first embodiment. Therefore, configurations similar to the first embodiment are either not shown or denoted with the same reference numbers.

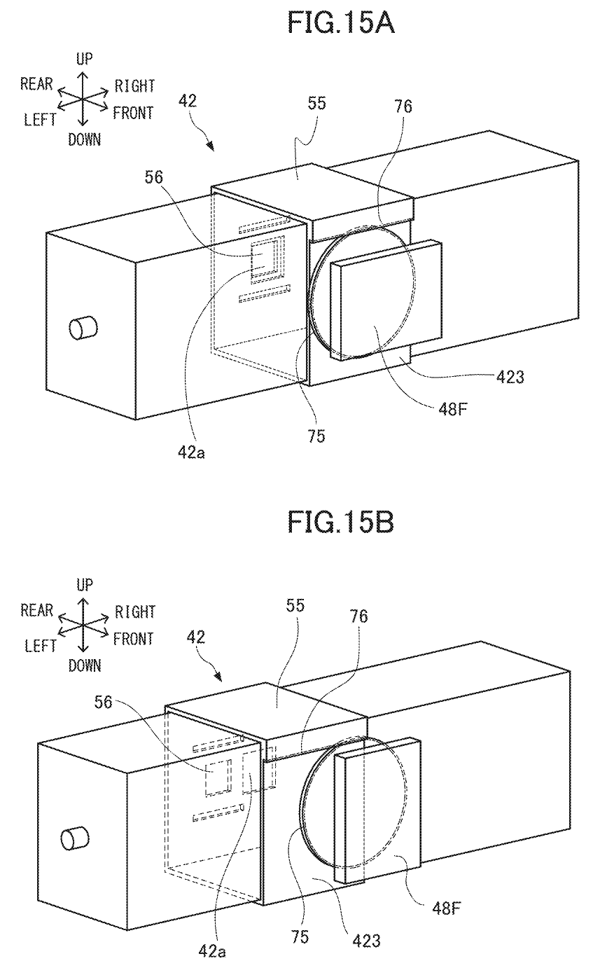

An operating portion according to the third embodiment will be described with reference to FIGS. 6B, 7B, 15A and 15B. FIGS. 15A and 15B are perspective views illustrating an operating portion according to the present embodiment. FIG. 15A illustrates a state where a holding portion 48F is at a first position. In the present configuration, the connecting portion 424 adopts the same configuration as FIG. 7B, such that descriptions thereof are omitted. FIG. 15B illustrates a state where the holding portion 48F is at a second position. In the present configuration, the connecting portion 424 adopts the same configuration as FIG. 6B, such that descriptions thereof are omitted.

As illustrated in FIG. 15A, the operating portion includes the holding portion 48F, the coupling portion 55, a pinion portion 75, and a rack portion 76. The pinion portion 75 is a drive transmission portion assembled to the holding portion 48F. The rack portion 76 is a drive transmitted portion formed on the coupling portion 55. As illustrated in the drawing, the pinion portion 75 and the rack portion 76 are meshed with each other. When the pinion portion 75 is driven to rotate, drive is transmitted to the rack portion 76. By the drive transmitted to the rack portion 76, the rack portion 76 moves to the right and left. In an interlocked manner with the movement of the rack portion 76, the coupling portion 55 moves to the right and left. The holding portion 48F is supported rotatably. The phase of the holding portion 48F in the drawing illustrates a state where it is rotated most clockwise. In this state, the operating portion 423F is moved to the right side, such that the outlet 42a and the communication outlet 56 correspond. Further, as illustrated in FIG. 7B, the engaging portion 58 is moved to the right side, such that it is engaged with the engaged portion 65.

As illustrated in FIG. 15B, when the holding portion 48F is moved counterclockwise in the drawing, the pinion portion 75 is also driven to rotate counterclockwise in the drawing. This driving force is transmitted as drive to the rack portion 76, and the coupling portion 55 moves to the left side. Then, as illustrated in the drawing, the outlet 42a is closed by the outlet shutter 54. As described, as illustrated in FIG. 6B, the engaging portion 58 moves to the left side, such that the engagement with the engaged portion 65 is disengaged.

As described above, according to the present embodiment, the holding portion 48F is supported rotatably. When the holding portion 48F is rotated clockwise in the drawing, the outlet 42a is opened, and the engaging portion 58 is moved to the engaged position. That is, when the holding portion 48F is fully rotated to the clockwise direction, the first position is taken. When the holding portion 48F is rotated counterclockwise from this state, the outlet 42a is closed, and the engaging portion 58 is at the disengaged position. That is, when the holding portion 48F is fully rotated to the counterclockwise direction, the second position is taken.

As described above with reference to the second embodiment and the third embodiment, the movement of the holding portion 48E or 48F may be the up-down movement or the rotational movement. These directions are approximately orthogonal to the attachment/detachment direction of the toner cartridge 42 and the process cartridge 41. Therefore, similar to the description of the first embodiment, erroneous operation between the switching operation and the attachment and detachment operation may be prevented.

### Fourth Embodiment

Next, a fourth embodiment according to the present disclosure will be described. The fourth embodiment is composed by disposing a separation regulating portion 416 to the first embodiment. Therefore, configurations similar to the first embodiment are either not shown or denoted with the same reference numbers.

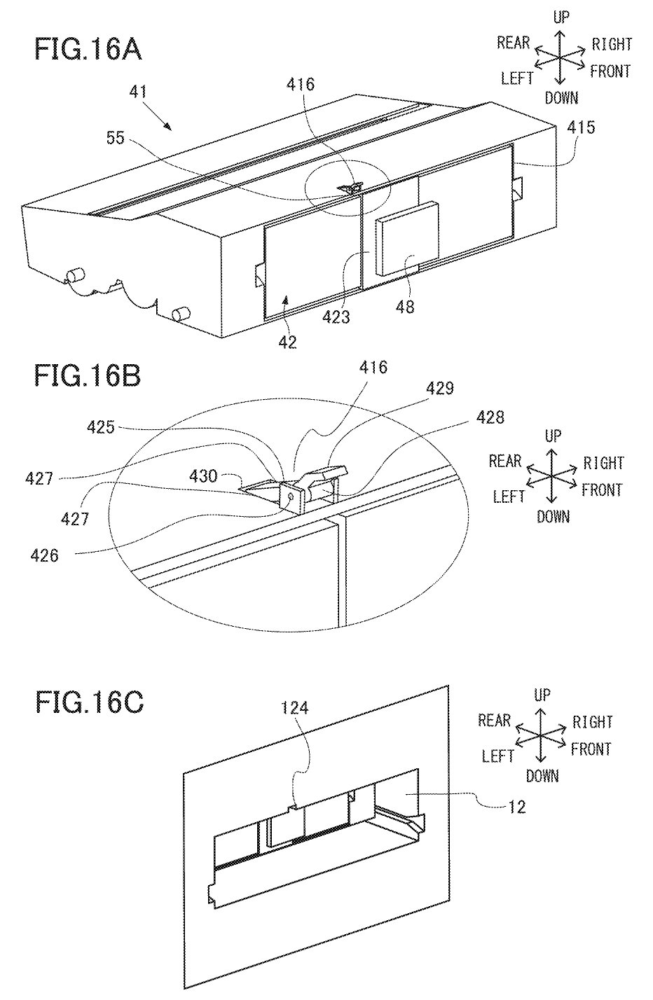

The fourth embodiment will be described with reference to FIGS. 16A - 17D. FIGS. 16A - 16C are perspective views illustrating the process cartridge 41 having the toner cartridge 42 connect thereto, and the cartridge opening 12. FIG. 16A is a perspective view illustrating the process cartridge 41 having the toner cartridge 42 connected thereto. FIG. 16B is a partial enlarged view having magnified the portion of FIG. 16A surrounded by the ellipse. FIG. 16C is a perspective view illustrating the cartridge opening 12.

As illustrated in FIG. 16A, the attachment portion 415 includes the separation regulating portion 416. The separation regulating portion 416 is arranged on a front side of the attachment portion 415 and left side of the coupling portion 55. As illustrated in FIG. 16B, the separation regulating portion 416 includes a regulation member 425, and a supporting member 426 that supports the regulation member 425 swingably. The regulation member 425 includes a stopper 427, a support shaft 428, and a disengagement portion 429. Meanwhile, the casing 410 of the process cartridge 41 includes the supporting member 426 and a stopper opening 430.

The stopper 427 is an example of a regulation portion that regulates movement of the holding portion 48 by being engaged with the coupling portion 55. The support shaft 428 is a center of swinging of the regulation member 425. The disengagement portion 429 is a portion that releases the engagement between the stopper 427 and the coupling portion 55. The stopper opening 430 is an opening formed on the casing 410. The stopper 427 arranged on the outer side of the attachment portion 415 is engaged via the stopper opening 430 with the coupling portion 55. Further, the stopper 427 is set to be heavier than the disengagement portion 429. As illustrated in FIG. 16C, a stopper release groove 124 is a groove formed on the cartridge opening 12. When attaching and detaching the process cartridge 41 to and from the apparatus body 1, the separation regulating portion 416 is set to correspond to the stopper release groove 124.

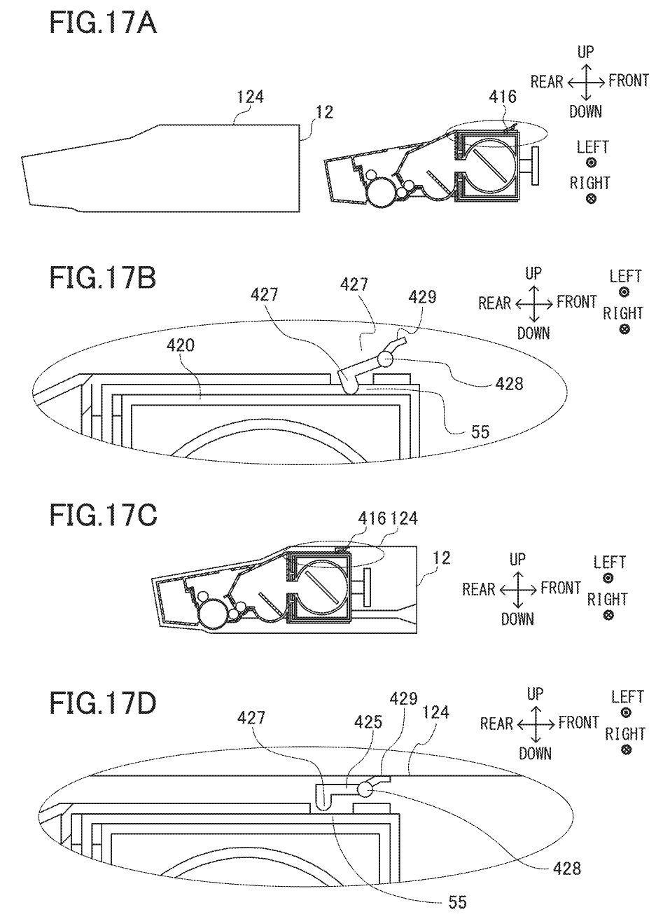

FIGS. 17A - 17D are perspective views illustrating the operation of the separation regulating portion 416. FIG. 17A illustrates a state where the process cartridge 41 having the toner cartridge 42 connected thereto is at the outer side of the apparatus body 1. FIG. 17B is a partial enlarged view having magnified the portion of FIG. 17A surrounded by the ellipse. FIG. 17C illustrates a state where the process cartridge 41 having the toner cartridge 42 connected thereto is attached to the apparatus body 1. FIG. 17D is an enlarged view having magnified the portion of FIG. 17C surrounded by the ellipse.

As illustrated in FIG. 17A, the regulation member 425 is supported swingably about the support shaft 428. Further, the stopper 427 is set to be heavier than the disengagement portion 429. Therefore, as illustrated in FIG. 17B, the stopper 427 swings in a counterclockwise direction in the drawing by its own weight, and the stopper 427 moves to a position in contact with the casing 420. The position at which the stopper 427 comes into contact with the casing 420 is set as a regulation position where movement of the holding portion 48 positioned at the first position toward the second position is regulated. That is, the separation regulating portion 416 is urged by its own weight to the regulation position in a state where the cartridge 100 is removed from the apparatus body 1.

The coupling portion 55 is movable in the left direction when it is at the first position. However, as illustrated in the drawing, the stopper 427 is engaged with the coupling portion 55. Therefore, the coupling portion 55 cannot move to the left. That is, according to the present embodiment, when the process cartridge 41 having the toner cartridge 42 connected thereto is at the exterior of the apparatus body 1, the movement of the holding portion 48 from the first position to the second position is regulated by the separation regulating portion 416, which is a separation regulation unit. By disposing the separation regulating portion 416 as described, it becomes possible to prevent the process cartridge 41 having the toner cartridge 42 connected thereto from being separated carelessly at the exterior of the apparatus body 1.

As illustrated in FIG. 17C, when the process cartridge 41 having the toner cartridge 42 connected thereto is attached to the apparatus body 1, the separation regulating portion 416 is moved to the inner side of the stopper release groove 124. As illustrated in FIG. 17D, when the separation regulating portion 416 enters the inner side of the stopper release groove 124 as illustrated in FIG. 17D, the disengagement portion 429 is engaged with the stopper release groove 124. Since the regulation member 425 is supported swingably, as illustrated in the drawing, the regulation member 425 swing in the counterclockwise direction in the drawing about the support shaft 428. Then, the engagement of the stopper 427 with the coupling portion 55 is released. The position at which the engagement of the stopper 427 with the coupling portion 55 has been released is referred to as a permission position where the movement of the holding portion 48 positioned at the first position toward the second position is permitted. The stopper release groove 124 is one example of a pushing portion capable of pushing the separation regulating portion 416, and by having the cartridge 100 push the separation regulating portion 416 when being attached to the apparatus body 1, the separation regulating portion 416 may be moved from the regulation position to the permission position. Thereby, when the process cartridge 41 is attached to the apparatus body 1 and the toner cartridge 42 is attached to the process cartridge 41, the stopper release groove 124 positions the stopper 427 at the permission position.

Therefore, the coupling portion 55 may move to the left. That is, according to the present embodiment, by attaching the process cartridge 41 having the toner cartridge 42 connected thereto to the apparatus body 1, regulation by the separation regulating portion 416 is released, and the holding portion 48 may be moved from the first position to the second position. As described, the separation regulating portion 416 may be separated automatically by attaching the process cartridge 41 having the toner cartridge 42 connected thereto to the apparatus body 1. Meanwhile, when replacing the process cartridge 41 with a new cartridge, if there is a need to separate the toner cartridge 42 and the process cartridge 41 outside the apparatus body 1, the regulation of movement of the holding portion 48 is released by simply pushing the disengagement portion 429 downward.

As described above, according to the cartridge 100 of the present embodiment, the process cartridge 41 having the toner cartridge 42 connected thereto outside the apparatus body 1 may be prevented from being separated carelessly by providing the separation regulating portion 416. Further, according to the present embodiment, a configuration of disposing the separation regulating portion 416 on the process cartridge 41 has been described, but the present technique is not limited thereto, and the separation regulating portion 416 may also be arranged on the toner cartridge 42.

According to the present embodiment described above, an example has been described where the separation regulating portion 416 is urged to the regulation position by its own weight, but the present technique is not limited thereto. For example, it may be possible to provide an urging spring of urging the separation regulating portion 416 to the regulation position. In that case, the direction in which the separation regulating portion 416 is moved to the regulation position may be realized to be a direction other than the gravity direction, such that the freedom of design may be improved.

### Fifth Embodiment

Next, a fifth embodiment according to the present disclosure will be described. The fifth embodiment is composed by changing the configuration of the attachment portion 415 and the connecting portion 424 of the first embodiment. Therefore, configurations similar to the first embodiment are either not shown or denoted with the same reference numbers.

### Attachment Portion and Connecting Portion

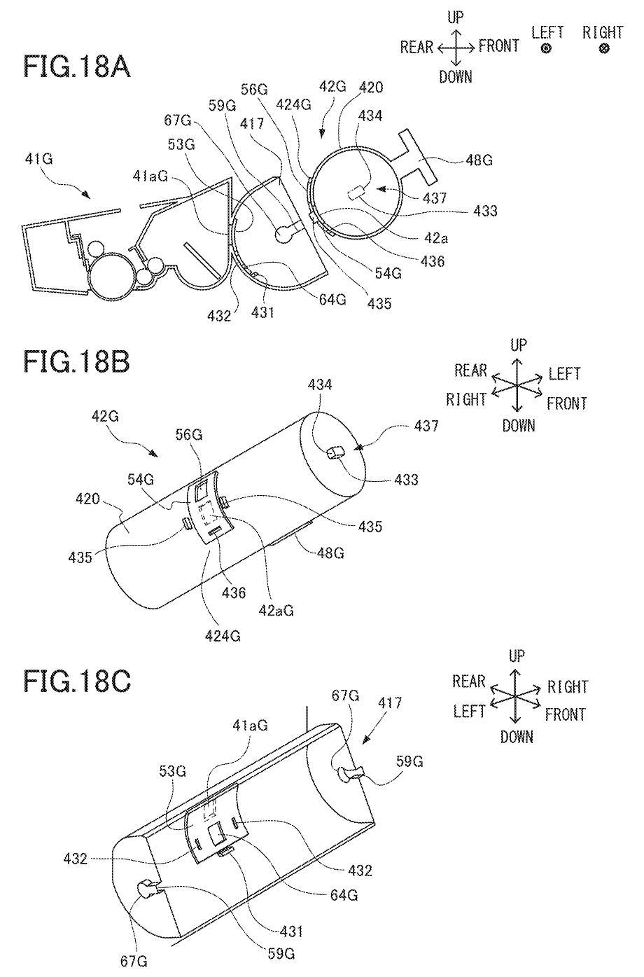

An attachment portion 417 and a connecting portion 424G of the fifth embodiment will be described with reference to FIGS. 18A - 18C. FIGS. 18A - 18C are views illustrating a toner cartridge 42G and a process cartridge 41G according to the present embodiment. FIG. 18A is a cross-sectional view illustrating a state where the toner cartridge 42G and the process cartridge 41G are separated. FIG. 18B is a perspective view of the toner cartridge 42G. FIG. 18C is a perspective view of the attachment portion 417.

As illustrated in FIG. 18A, the attachment portion 417 of the process cartridge 41G includes an inlet 41aG, an inlet shutter 53G, a rib 431 serving as an example of an outlet shutter engaged portion, guides 59G, and positioning portions 67G. The inlet shutter 53G includes a communication inlet 64G, and engagement holes 432 serving as an example of an inlet shutter engaging portion. The toner cartridge 42G includes a holding portion 48G, shaft portions 437, a connecting portion 424G, an outlet shutter 54G, and ribs 435 that serve as an example of an inlet shutter engaged portion. The outlet shutter 54G includes a communication outlet 56G, and an engagement hole 436 serving as an example of an outlet shutter engaging portion.

When the toner cartridge 42G is attached to the process cartridge 41G, the engagement hole 436 is engaged with the rib 431 by which the outlet shutter 54G and the process cartridge 41 are coupled. Further, when the toner cartridge 42G is attached to the process cartridge 41G, the engagement holes 432 is engaged with the ribs 435 by which the outlet shutter 54G and the process cartridge 41 are coupled. The shaft portions 437 are an example of an engaging portion, which are provided integrally on the casing 420, and which include guide receiving portions 433, which are small diameter portions having a shorter diameter than the width of the guides 59G, and positioning receiving portions 434 having a longer diameter than the width of the guides 59G.

As illustrated in FIG. 18B, the holding portion 48G is disposed integrally on the casing 420, and which is a portion corresponding to the holding portions 48 to 48E described in the first to fourth embodiments. That is, the holding portion 48G is disposed integrally on the casing 420, and moves together with the casing 420 when moving between the first and second positions. The guide receiving portions 433 and the positioning receiving portions 434 are formed on both end surfaces on the right and left sides of the casing 420. The guide receiving portions 433 are engaged portions that are engaged with the guides 59G. The guide receiving portions 433 are guide portions that guide the movement locus when connecting and separating the toner cartridge 42 to and from the process cartridge 41 by being engaged with the guides 59G. The positioning receiving portions 434 are positioning portions that position the toner cartridge 42 by being engaged with the positioning portions 67G. In the present embodiment, the engaged portions include the guides 59G which are arranged such that one end portion is opened at an edge portion of the casing 410, and the positioning portions 67G which are arranged successively to the other end portion of the guides 59G and that have a larger diameter than the width of the guides 59G.

The outlet shutter 54G is an example of a movement member, which is a shutter member movable along an arc-shaped locus along a circumference surface of the casing 420, and which opens and closes an outlet 42aG. The communication outlet 56G is an opening formed on the outlet shutter 54G. When the outlet shutter 54G is moved to the open position and corresponds to the outlet 42aG, toner stored in the toner cartridge 42G may be discharged. The engagement hole 436 is an opening formed on the outlet shutter 54G, and it is engaged with the rib 431. The ribs 435 are projected portions arranged on the right and left sides of the outlet shutter 54G, and they are engaging portions that engage with the engagement holes 432.

As illustrated in FIG. 18C, the inlet 41aG is an opening formed on the attachment portion 417. The inlet 41aG is an opening through which toner is received. The inlet shutter 53G is a shutter member for opening and closing the inlet 41aG. The engagement holes 432 are formed on the right and left sides of the inlet shutter 53G. The rib 431 is a rib-shaped member arranged on the attachment portion 417. The communication inlet 64G is an opening formed on the inlet shutter 53G. When the inlet shutter 53G is moved to the open position and corresponds to the inlet 41aG, toner discharged from the toner cartridge 42 may be received into the process cartridge 41. The guides 59G are groove-shaped and formed on the inner walls on right and left sides of the attachment portion 417, which serve as guide portions for guiding the movement locus when connecting and separating the toner cartridge 42, and which engage with the guide receiving portions 433. The positioning portions 67G are arc-shaped recess portions. The positioning of the toner cartridge 42 is enabled by being engaged with the arc-shaped portions of the positioning receiving portions 434.

### Connection and Separation of Toner Cartridge and Process Cartridge, and Opening and Closing Movement of Shutter

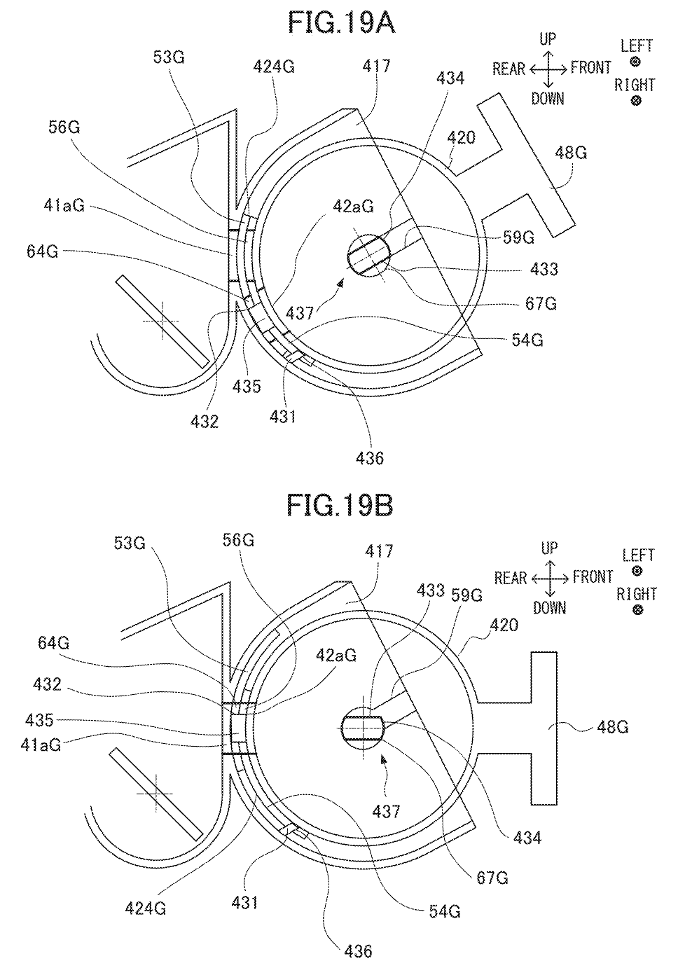

Next, the connection and separation of the toner cartridge 42G and the process cartridge 41G and the opening and closing movement of the shutter will be described with reference to FIGS. 19A and 19B. FIGS. 19A and 19B are partially magnified perspective views of the connecting portion 424G between the attachment portion 417 and the process cartridge 41G according to the present embodiment. FIG. 19A illustrates a state in which the toner cartridge 42G is moved to the attachment portion 417 of the process cartridge 41G. In the drawing, the toner cartridge 42G and the process cartridge 41G are separable. That is, in the state illustrated in the drawing, the holding portion 48G is at the second position.

FIG. 19B illustrates a state in which the toner cartridge 42G is attached to the attachment portion 417 of the process cartridge 41G. In the drawing, the toner cartridge 42G and the process cartridge 41G are connected. That is, in the state illustrated in the drawing, the holding portion 48G is at the first position.

As illustrated in FIG. 19A, in a state where the toner cartridge 42G is attached to the process cartridge 41G, the user moves the holding portion 48G to the front toward the attachment portion 417. Next, positioning of the guides 59G on the attachment portion 417 and the guide receiving portions 433 on the toner cartridge 42G is performed. The toner cartridge 42G is moved obliquely along the guides 59G. By the positioning portions 67G and the positioning receiving portions 434 being abutted against each other, movement is stopped. In this state, by having the arc of the positioning portions 67G and the arc of the positioning receiving portions 434 fit to each other, the positions of the toner cartridge 42G and the process cartridge 41G are determined. Further, as illustrated in the drawing, the rib 431 and the engagement hole 436 are engaged, and the ribs 435 and the engagement holes 432 are also engaged. That is, when attaching and detaching the toner cartridge 42G to and from the process cartridge 41G, attachment and detachment is performed such that the guide receiving portions 433 of the shaft portions 437 pass through the guides 59G.

As illustrated in FIG. 19B, the user swings the holding portion 48G in the clockwise direction in the drawing. Along with the swinging movement, as illustrated in the drawing, the positioning receiving portions 434 swing. Since the positioning receiving portions 434 are greater than the guides 59G, the toner cartridge 42G will be connected to the process cartridge 41G. Since the rib 431 and the engagement hole 436 are engaged, the outlet shutter 54G will not move. Therefore, as illustrated in the drawing, the outlet 42aG is moved to a position corresponding to a communication port 4252.

Meanwhile, since the ribs 435 and the engagement holes 432 are engaged, along with the swinging movement, the communication inlet 64G of the inlet shutter 53G is moved to a position corresponding to the inlet 41aG. Then, the outlet 42aG the communication outlet 56G, the communication inlet 64G, and the inlet 41aG are all communicated. Therefore, toner stored in the toner cartridge 42G may be conveyed to the process cartridge 41G. In this state, if the holding portion 48G is pulled out to the front side horizontally, the toner cartridge 42G and the process cartridge 41G may be removed from the apparatus body 1 while maintaining the connected state.

In order to release the connection between and separate the toner cartridge 42G and the process cartridge 41G, the holding portion 48G is swung counterclockwise in the drawing to realize the state of FIG. 19A. By executing this operation, the phases of the guide receiving portions 433 and the guides 59G correspond, and the connection between the toner cartridge 42G and the process cartridge 41G is released, such that separation is enabled. Further, the outlet 42aG is closed by the outlet shutter 54G and the inlet 41aG is closed by the inlet shutter 53G.

As described above, the position of the holding portion 48G illustrated in FIG. 19B corresponds to the first position described in the first embodiment. Further, the position of the holding portion 48G illustrated in FIG. 19A correspond to the second position described in the first embodiment. The first embodiment adopts a configuration in which the holding portion 48 is movable with respect to the casing 420. Meanwhile, according to the present embodiment, the holding portion 48G is fixed integrally to the casing 420. As described, in any of the configurations, the switching operation of switching the cartridge to be attached and detached and the attachment and detachment operation of attaching and detaching the selected cartridge may be performed by simply operating the holding portion 48G on the toner cartridge, such that the operation may be simplified.

According to the present embodiment, the direction in which the toner cartridge 42G alone is attached and detached differs from the direction in which the process cartridge 41G having the toner cartridge 42G connected thereto is attached and detached. According to the configuration, an urging means such as the urging springs 66 described in the first embodiment becomes unnecessary. In the first embodiment, the direction in which the toner cartridge 42G alone is attached and detached is the same as the direction in which the process cartridge 41G having the toner cartridge 42G connected thereto is attached and detached. Therefore, measures must be taken to prevent the process cartridge 41G to be drawn out together when drawing out the toner cartridge 42G alone. However, according to the present embodiment, the attachment/detachment directions differ, such that countermeasures are not necessary.

### Other Embodiments

In all the embodiments described above, the toner cartridge 42 includes the outlet shutter 54, but the present technique is not limited thereto. For example, the toner cartridge 42 may not be provided with the outlet shutter 54. In that case, for example, a new toner cartridge 42 may have a sealing sticker attached to the outlet 42a, and prior to use, the sealing sticker is peeled off and the toner cartridge is attached to the process cartridge 41. When toner in the toner cartridge 42 is consumed, there is a small risk of having toner leak from the opened outlet 42a when the toner cartridge 42 is removed in that state, since there is only very little toner left in the cartridge.

Further, according to the embodiments described above, a configuration has been described where the drum icon 69 and the toner icon 68 are disposed on the casing 420, and display is selected by hiding the icon by the operating portion 423 interlocked with the holding portion 48, but the present technique is not limited thereto. That is, any mechanism may be adopted that displays a state indicating which of the first and second positions the holding portion 48 is positioned. For example, an arrow mark may be provided on the operating portion 423 interlocked with the holding portion 48, and a drum icon and a toner icon may be provided on areas to which the arrow points.

According to the embodiments described above, the image forming apparatus 10 including the document reading unit 8 has been described as an example, but the present technique is not limited thereto, and the document reading unit 8 may be omitted.

Further according to the embodiments described above, the front cover 11 is disposed on the front side of the apparatus body 1, and the toner cartridge 42 and the process cartridge 41 are drawn out to the front side of the apparatus body 1, but the present technique is not limited thereto. For example, the front cover 11 may be provided on either the left side or the right side of the apparatus body 1, or on the rear side thereof. In that case, the toner cartridge 42 and the process cartridge 41 may be drawn out to the right side, the left side, or the rear side.

Further, according to the embodiments described above, the image forming apparatus 10 being a monochromatic laser printer has been described as an example, but the present technique is not limited thereto. For example, the present technique may be applied to an image forming apparatus, which is a full-color laser printer. In that case, the image forming apparatus includes a plurality of process cartridges, which may correspond to four colors of yellow, magenta, cyan, and black, and each process cartridge may include the process cartridge 41 and the toner cartridge 42.

Further according to the embodiments described above, the process cartridge 41 includes the photosensitive drum 411, the charge roller 412, and the developing roller 44, but the present technique is not limited thereto. For example, the process cartridge 41 may not include the developing roller 44, and the toner cartridge 42 may include the developing roller 44.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2023-184921, filed Oct. 27, 2023, which is hereby incorporated by reference herein in its entirety.

What is claimed is:

1-33. (canceled)

34. A cartridge configured to be attached to and detached from an apparatus body of an image forming apparatus, the cartridge comprising:
a toner storage unit; and
a developing unit configured such that the toner storage unit is attached to and detached from the developing unit in a first direction,
wherein the toner storage unit includes:
a first toner storage portion configured to accommodate toner and provided with an outlet through which toner is discharged;
a conveyance member configured to convey toner accommodated in the first toner storage portion toward the outlet of the first toner storage portion; and
a movement member movable with respect to the first toner storage portion and including an engaging portion and an operating portion,
wherein the developing unit includes:
a developing roller configured to rotate about a rotational axis extending in a direction intersecting the first direction and to bear toner;
a developing frame body supporting the developing roller rotatably and including a second toner storage portion configured to accommodate toner and provided with an inlet configured to communicate with the outlet of the first toner storage portion; and
an engaged portion configured to be engaged with the engaging portion of the movement member,
wherein the movement member is configured to be movable between a first position and a second position by the operating portion being operated by a user,
wherein the first direction includes an attachment direction in which the toner storage unit is attached to the developing unit and a detachment direction in which the toner storage unit is detached from the developing unit, the detachment direction being a direction opposite to the attachment direction,
wherein the first position is a position where (i) the engaging portion is in engagement with the engaged portion such that detachment of the toner storage unit from the developing unit in the detachment direction is restricted, (ii) the outlet of the first toner storage portion and the inlet of the second toner storage portion are in communication with each other, and (iii) the toner storage unit is detachable from the apparatus body integrally with the developing unit in a case where the toner storage unit is moved in the detachment direction,
wherein the second position is a position where (iv) the engaging portion is not in engagement with the engaged portion such that the toner storage unit is detachable from the developing unit in the detachment direction, (v) the outlet of the first toner storage portion and the inlet of the second toner storage portion are not in communication with each other, and (vi) the toner storage unit is detachable from the developing unit in a state where the developing unit remains attached to the apparatus body,
wherein the toner storage unit includes a flat outer surface provided in a region of a downstream end surface of the toner storage unit in the detachment direction, the region of the downstream end surface extending in a direction of the rotational axis and encompassing a center of the toner storage unit in the direction of the rotational axis, and
wherein the outlet is provided at a center portion of the toner storage unit in the direction of the rotational axis on an upstream end surface of the toner storage unit in the detachment direction, and is open toward the attachment direction.

35. The cartridge according to claim 34, wherein the operating portion is provided in a portion of the movement member on the same side of the movement member as the flat outer surface in the first direction, and
wherein the engaging portion is provided in a portion of the movement member on a side of the movement member opposite to the flat outer surface in the first direction.

36. The cartridge according to claim 34, wherein the outlet is open to an approximately cylindrical inner surface forming the first toner storage portion.

37. The cartridge according to claim 36, wherein the conveyance member is a paddle configured to rotate inside the first toner storage portion about a center of rotation, and
wherein the outlet is provided on a side of the toner storage unit opposite to the flat outer surface with respect to the center of rotation in the first direction.

38. The cartridge according to claim 34, wherein the toner storage unit further includes a first indicating portion and a second indicating portion that are provided on the flat outer surface,
wherein the first indicating portion is configured to indicate that detachment of the toner storage unit from the developing unit is restricted, and
wherein the second indicating portion is configured to indicate that detachment of the toner storage unit from the developing unit is permitted.

39. The cartridge according to claim 34, wherein the movement member includes an outlet shutter portion configured to open the outlet when the movement member is positioned at the first position, and to close the outlet when the movement member is positioned at the second position.

40. The cartridge according to claim 34, wherein a longitudinal direction of the toner storage unit is the direction of the rotational axis of the developing roller.

41. The cartridge according to claim 34, wherein the developing unit further includes a photosensitive drum configured to receive supply of toner from the developing roller.

42. The cartridge according to claim 39, wherein the developing unit includes an inlet shutter configured to be movable with respect to the second toner storage portion in an interlocked manner with the outlet shutter portion, such that the inlet shutter opens the inlet in a state where the movement member is at the first position and the inlet shutter closes the inlet in a state where the movement member is at the second position.

43. The cartridge according to claim 42, wherein the outlet shutter portion includes a shutter engaging portion, and
wherein the inlet shutter includes a shutter engaged portion configured to be engaged with the shutter engaging portion in a state where the toner storage unit is attached to the developing unit, such that the inlet shutter is interlocked with the outlet shutter portion.

44. The cartridge according to claim 34, further comprising:
a restriction portion configured to move between a restriction position in which the restriction portion restricts movement of the movement member positioned at the first position toward the second position, and a permission position in which the restriction portion permits the movement of the movement member positioned at the first position toward the second position.

45. An image forming apparatus configured to form an image on a sheet, the image forming apparatus comprising:
an apparatus body having an opening;
a door configured to open and close the opening of the apparatus body; and
a cartridge attached to the apparatus body and configured to be attachable to and detachable from the apparatus body through the opening,
wherein the cartridge includes a toner storage unit and a developing unit configured such that the toner storage unit is attached to and detached from the developing unit in a first direction,
wherein the toner storage unit includes:
a first toner storage portion configured to accommodate toner and provided with an outlet through which toner is discharged;
a conveyance member configured to convey toner accommodated in the first toner storage portion toward the outlet of the first toner storage portion; and
a movement member movable with respect to the first toner storage portion and including an engaging portion and an operating portion,
wherein the developing unit includes:
a developing roller configured to rotate about a rotational axis extending in a direction intersecting the first direction and to bear toner;
a developing frame body supporting the developing roller rotatably and including a second toner storage portion configured to accommodate toner and provided with an inlet configured to communicate with the outlet of the first toner storage portion; and
an engaged portion configured to be engaged with the engaging portion of the movement member,
wherein the movement member is configured to be movable between a first position and a second position by the operating portion being operated by a user,
wherein the first direction includes an attachment direction in which the toner storage unit is attached to the developing unit and a detachment direction in which the toner storage unit is detached from the developing unit, the detachment direction being a direction opposite to the attachment direction,
wherein the first position is a position where (i) the engaging portion is in engagement with the engaged portion such that detachment of the toner storage unit from the developing unit in the detachment direction is restricted and such that the toner storage unit and the developing unit are integrally attached to and detached from the apparatus body through the opening, and (ii) the outlet of the first toner storage portion and the inlet of the second toner storage portion are in communication with each other,
wherein the second position is a position where (iii) the engaging portion is not in engagement with the engaged portion such that the toner storage unit is attachable to and detachable from the developing unit through the opening in a state where the developing unit remains attached to the apparatus body, and (iv) the outlet of the first toner storage portion and the inlet of the second toner storage portion are not in communication with each other,
wherein the toner storage unit includes a flat outer surface provided in a region of a downstream end surface of the toner storage unit in the detachment direction, the region of the downstream end surface extending in a direction along an inner surface of the door in a state where the door closes the opening and encompassing a center of the toner storage unit in the direction of the rotational axis, and
wherein the outlet is provided at a center portion of the toner storage unit in the direction of the rotational axis on an upstream end surface of the toner storage unit in the detachment direction, and is open toward the attachment direction.

46. The image forming apparatus according to claim 45, wherein the operating portion is provided in a portion of the movement member on the same side of the movement member as the flat outer surface in the first direction, and
wherein the engaging portion is provided in a portion of the movement member on a side of the movement member opposite to the flat outer surface in the first direction.

47. The image forming apparatus according to claim 45, wherein the outlet is open to an approximately cylindrical inner surface forming the first toner storage portion.

48. The image forming apparatus according to claim 47, wherein the conveyance member is a paddle configured to rotate inside the first toner storage portion about a center of rotation, and
wherein the outlet is provided on a side of the toner storage unit opposite to the flat outer surface with respect to the center of rotation in the first direction.

49. The image forming apparatus according to claim 45, wherein the toner storage unit further includes a first indicating portion and a second indicating portion that are provided on the flat outer surface,
wherein the first indicating portion is configured to indicate that detachment of the toner storage unit from the developing unit is restricted, and
wherein the second indicating portion is configured to indicate that detachment of the toner storage unit from the developing unit is permitted.

50. The image forming apparatus according to claim 45, wherein the door forms an exterior surface of the image forming apparatus in a state where the opening is closed.

51. The image forming apparatus according to claim 45, wherein the door is configured to close the opening in a state where the developing unit is attached to the apparatus body and the toner storage unit is attached to the developing unit, and
wherein, in a state where the opening is closed by the door, the toner storage unit is not exposed to an exterior of the image forming apparatus.

52. The image forming apparatus according to claim 45, wherein, in a state where the developing unit is attached to the apparatus body and the toner storage unit is attached to the developing unit, an entirety of the toner storage unit is accommodated in an interior of the apparatus body.

53. The image forming apparatus according to claim 45, wherein the developing unit includes a first positioning portion and a first urging portion,
wherein the toner storage unit includes a first positioned portion configured to be positioned by being in contact with the first positioning portion to position the toner storage unit in a state attached to the developing unit, and
wherein the first urging portion is configured to urge the first positioned portion to be in contact with the first positioning portion.

54. The image forming apparatus according to claim 53,
wherein the apparatus body includes a second positioning portion and a second urging portion,
wherein the developing unit includes a second positioned portion configured to be positioned by being in contact with the second positioning portion to position the developing unit in a state attached to the apparatus body,
wherein the second urging portion is configured to urge the second positioned portion to be in contact with the second positioning portion, and
wherein an urging force of the first urging portion and an urging force of the second urging portion are set such that, in a state where the developing unit is attached to the apparatus body, where the toner storage unit is attached to the developing unit, and where the movement member is positioned at the second position, the toner storage unit is detachable from the developing unit with the developing unit still attached to the apparatus body.

55. The image forming apparatus according to claim 45, wherein the cartridge includes a restriction portion configured to move between a restriction position in which movement of the movement member positioned at the first position toward the second position is restricted, and a permission position in which the movement of the movement member positioned at the first position toward the second position is permitted.

56. The image forming apparatus according to claim 55, wherein the apparatus body includes a pushing portion configured to push the restriction portion,
wherein the restriction portion is configured to be urged to the restriction position in a state where the cartridge is detached from the apparatus body, and
wherein the pushing portion is configured to push the restriction portion to move the restriction portion from the restriction position to the permission position when the cartridge is attached to the apparatus body.

57. The image forming apparatus according to claim 55, wherein the restriction portion is configured to be urged to the restriction position by its own weight.

58. The image forming apparatus according to claim 45,
wherein the developing unit includes a photosensitive drum configured to bear a toner image formed by receiving supply of toner from the developing roller,
wherein the apparatus body includes:
a stacking portion on which a sheet is stacked;
a feeding roller configured to feed the sheet from the stacking portion;
a transfer roller configured to form, together with the photosensitive drum, a transfer nip through which the sheet is conveyed while the toner image is transferred from the photosensitive drum to the sheet;
a fixing unit having a fixing nip through which the sheet is conveyed while the toner image transferred to the sheet at the transfer nip is fixed to the sheet;
a discharge roller configured to discharge the sheet to which the toner image has been fixed at the fixing nip to an exterior of the apparatus body; and
a discharge tray on which the sheet discharged by the discharge roller is stacked, and
wherein a direction in which the sheet is conveyed from the transfer nip toward the fixing nip is opposite to a direction in which the feeding roller feeds the sheet stacked on the stacking portion and a direction in which the discharge roller discharges the sheet onto the discharge tray.

59. The image forming apparatus according to claim 58, wherein the cartridge is the only cartridge provided in the image forming apparatus.
